(19) United States
(12) Patent Application Publication
(10) Pub. No.: US 2020/0327449 A1
(43) Pub. Date: Oct. 15, 2020

(54) USER RETENTION PLATFORM

(71) Applicant: Accenture Global Solutions Limited, Dublim (IE)

(72) Inventors: Sanjay TIWARI, Bangalore (IN); Binit AGRAWAL, Bangalore (IN); Badarayan PANIGRAHI, Bangalore (IN); Ashish A. GOYAL, Bangalore (IN); Varun MATHUR, Ajmer (IN)

(21) Appl. No.: 16/384,598

(22) Filed: Apr. 15, 2019

(51) Int. Cl. G06N 20/00; G06N 5/02; H04L 12/24

(52) U.S. Cl. CPC G06N 20/00; H04L 41/5067; H04L 41/5009; G06N 5/02

(57) ABSTRACT

A device identifies, by using a first model to process a first weighted feature set, users who are predicted to stop using a service provider for one or more services. The device determines, by using a second model to process a second weighted feature set, user scores for the users who represent predicted value that the users provide to the service provider. The device identifies, based on the user scores, particular users, of the users, as targets to be offered additional services. The device determines, by using a third model to process a third weighted feature set, service scores that represent predicted levels of interest of a user, of the particular users, in a set of services. The device selects services based on the service scores. The device causes a services package that includes the services to be provided to a user device or an account associated with the user.

### BACKGROUND

Machine learning is a field of computer science that gives computers the ability to learn without being explicitly programmed. For example, a machine learning model may be trained on a set of training data, such that the model may be used to process live data to generate useful predictions and/or classifications.

### SUMMARY

According to some implementations, a method may include determining, by a device, that a condition is satisfied that causes the device to determine whether to offer additional services to particular users of a group of users who have accounts with a service provider. The method may include receiving, by the device, user data associated with the group of users. The user data includes at least one of: user account data, user behavioral data, or technical support data. The method may include receiving, by the device, a set of network performance indicator (NPI) values that measure network performance of a network that is accessible to user devices associated with the group of users. The method may include determining, by the device and by processing the user data and the set of NPI values, a first set of weighted features that affect likelihoods that the group of users will stop using the service provider for one or more services. The method may include identifying, by the device and by using a first data model to process the first set of weighted features, a subgroup of users, of the group of users, that are predicted to stop using the service provider for one or more services. The method may include determining, by the device and by processing a subset of the user data that corresponds to the subgroup of users who have been identified, a second set of weighted features that are indicative of contributing to a value that the subgroup of users provide to the service provider. The method may include determining, by the device and by using a second data model to process the second set of weighted features, a set of user scores for the subgroup of users. The set of user scores may represent predicted value that the subgroup of users provide to the service provider. The method may include identifying, by the device and based on the set of user scores, one or more users, of the subgroup of users, as targets that are to be offered one or more additional services. The method may include determining, by the device and by processing particular user data that corresponds to a user of the one or more users who have been identified as targets, a third set of weighted features that are indicative of a level of interest in particular services. The method may include determining, by the device and by using a third data model to process the third set of weighted features, a set of service scores that represent predicted levels of interest of the user in a set of services. The method may include selecting, by the device and based on the set of service scores, one or more services of the set of services. The method may include causing, by the device, a services package that includes the one or more services to be provided to a user device or an account associated with the user to permit the user device or the account to be used to accept the services package.

According to some implementations, a device may include one or more memories, and one or more processors, operatively coupled to the one or more memories, to receive user data associated with a group of users who have accounts with a service provider. The user data may include at least one of user account data, user behavioral data, or technical support data. The device may determine, by processing the user data, user statistics data for the group of users. The device may determine, by processing the user data and the user statistics data, a first set of features that are indicative of contributing to user churn rates. The device may identify, by using a first module of a data model to process the first set of features, a subgroup of users, of the group of users, that are predicted to stop using the service provider. The device may determine, by processing a subset of the user data that corresponds to the subgroup of users who have been identified, a second set of features that are indicative of value that the subgroup of users provide to the service provider. The device may determine, by using a second module of the data model to process the second set of features, a set of user scores for the subgroup of users. A user score, of the set of user scores, may represent a predicted value that a particular user is to provide to the service provider. The device may identify, based on the set of user scores, one or more users, of the subgroup of users, as targets that are to be offered one or more additional services. The device may determine, by processing particular user data that corresponds to a user of the one or more users who have been identified as targets, a third set of features that are indicative of a level of interest in particular services. The device may determine, by using a third module of the data model to process the third set of features, a set of service scores that represent predicted levels of interest of the user in a set of services. The device may select, based on the set of service scores, one or more services of the set of services. The device may cause a services package that includes the one or more services to be provided to a user device or an account associated with the user.

According to some implementations, a non-transitory computer-readable medium may store one or more instructions. The one or more instructions, when executed by one or more processors of a device, may cause the one or more processors to receive user data associated with a group of users who have accounts with a service provider. The user data may include user account data and user behavioral data. The one or more instructions may cause the one or more processors to receive a set of network performance indicator (NPI) values that measure network performance of a network that is accessible to user devices associated with the group of users. The one or more instructions may cause the one or more processors to determine, by processing the user data and the set of NPI values, a first set of weighted features that are indicative of contributing to user churn rates. The one or more instructions may cause the one or more processors to identify, by performing a first machine-learning-driven analysis of the first set of weighted features, a subgroup of users, of the group of users, that are predicted to stop using the service provider. The one or more instructions may cause the one or more processors to determine, by processing a subset of the user data that corresponds to the subgroup of users, a second set of weighted features that are indicative of a level of interest in particular services. The one or more instructions may cause the one or more processors to determine, by performing a second machine-learning-driven analysis of the second set of weighted features, a set of service scores that represent predicted levels of interest that the subgroup of users have in a set of services. The one or more instructions may cause the one or more processors to select, for a user, of the subgroup of users, one or more services of the set of services based on particular service scores of the set of service scores. The one or more instructions may cause the one or more processors to cause a services package that includes the one or more services to be provided to a user device or an account associated with the user to permit user device or the account to be used to accept the services package.

### BRIEF DESCRIPTION OF THE DRAWINGS

FIGS. 1A-1I are diagrams of one or more example implementations described herein.

FIG. 2 is a diagram of an example environment in which systems and/or methods described herein may be implemented.

FIG. 3 is a diagram of example components of one or more devices of FIG. 2.

FIGS. 4-6 are flowcharts of one or more example processes for identifying users who are predicted to stop using services of a service provider, for identifying that one or more of the users are high-value customers to the service provider, for identifying one or more additional services that are predicted to be of interest to a user, of the one or more users, and for causing a services package with the one or more additional services to be provided to a user device or user account associated with the user.

### DETAILED DESCRIPTION

The following detailed description of example implementations refers to the accompanying drawings. The same reference numbers in different drawings may identify the same or similar elements.

Customer churn (referred to hereafter as user churn) is an issue in the telecommunication industry. When a customer (referred to hereafter as a user) attempts to leave a telecommunication provider for a competitor, the telecommunication provider often attempts to retain the user by offering various sales and deals. However, these sales and deals are an ineffective method of user retention as the user has already decided to move to the competitor at a time when the sales and deals are offered. This causes the telecommunication provider to lose revenue and causes devices associated with the telecommunication provider to waste processing resources, network resources, memory resources, and/or the like. For example, by using a network device to generate and transmit data that includes sales and deals for a user to a user device, after the user has already decided to switch to a competitor, processing resources of the network device are wasted to generate and transmit the data, network resources of network devices are wasted to relay the data to the user device, and resources of the user device are wasted when receiving and/or displaying the data.

Additionally, there is not an efficient and effective way to prioritize which users to retain. For example, different users add different amounts of value to the service (e.g., based on revenue, positive reviews, and/or the like). Without a way to prioritize which users to attempt to retain, device resources (e.g., processing resources, network resources, memory resources, and/or the like) may be wasted attempting to retain users who are low-value customers during a critical window where the device resources would be more effectively spent attempting to retain users who are high-value customers.

Furthermore, there is not a way to efficiently and effectively retain the users who are high-value customers. For example, the telecommunication provider may offer a discount or a sale to a user, but if the user is unhappy with a quality of service, simply providing a reduced price may not be enough to convince the user to continue using services of the telecommunication provider. This wastes device resources by generating and providing discounts and sales only to have the discounts and sales rejected by the user.

Some implementations described herein provide a user retention platform to identify a subgroup of users who are likely to stop using a service provider for one or more services, to identify one or more users, of the subgroup of users, as being high-value customers to the service provider, to identify additional services that are predicted to be of interest to the one or more users, and to cause services packages that include the additional services to be provided to user devices or accounts associated with the one or more users. For example, the user retention platform may receive user data associated with a group of users who have accounts with the service provider, and may receive a set of network performance indicator (NPI) values that measure network performance of a network that is accessible to user devices associated with the group of users. In this case, the user retention platform may process the user data and the set of NPI values to determine a first set of weighted features that are indicative of likelihoods that the users in the group of users will stop using the service provider for the one or more services. This may allow the user retention platform to use a first data model to process the first set of weighted features to identify the subgroup of users who are predicted to stop using the service provider for one or more services.

Additionally, the user retention platform may process the user data and the NPI values associated with the subgroup of users to determine a second set of weighted features that are indicative of value that particular users, in the subgroup of users, provide to the service provider. In this case, the user retention platform may use a second data model to process the second set of weighted features to determine a set of user scores that represent predicted value that the subgroup of users provide to the services provider. This may allow the user retention platform to select one or more users, of the subgroup of users, as targets that are to be offered the services packages that include the additional services.

Furthermore, the user retention platform may process the user data associated with the one or more users to determine a third set of weighted features that are indicative of a level of interest in particular services. In this case, the user retention platform may process the first set of weighted features using a third data model to determine a set of service scores that represent predicted levels of interest of the one or more users in the set of services. This may allow the user retention platform to select the additional services, from the set of services, and to perform one or more actions to cause the services packages that include the additional services to be provided to the user devices or the accounts associated with the one or more users.

In this way, the user retention platform provides services packages to users (e.g., high-value customers), thereby increasing chances of retaining the users and reducing a user churn rate. By intelligently identifying the group of users who are likely to stop using the service provider, the user retention platform conserves resources (e.g., processing resources, network resources, memory resources, and/or the like) that would otherwise be wasted generating and transmitting data that includes ineffective sales and deals to a group of user devices or accounts associated with users who were not planning to leave the service provider. Furthermore, by determining the set of user scores and by selecting the subgroup of users who have user scores indicative of being high-value customers to the service provider, the user retention platform conserves resources that would otherwise be wasted attempting to retain users who are low-value customers. Moreover, by identifying services that are predicted to be of interest to the subgroup of users and by recommending those services to the subgroup of users, the user retention platform conserves resources that would otherwise be wasted to generate and provide the subgroup of users with ineffective offers that are unlikely to retain the subgroup of users as customers of the service provider.

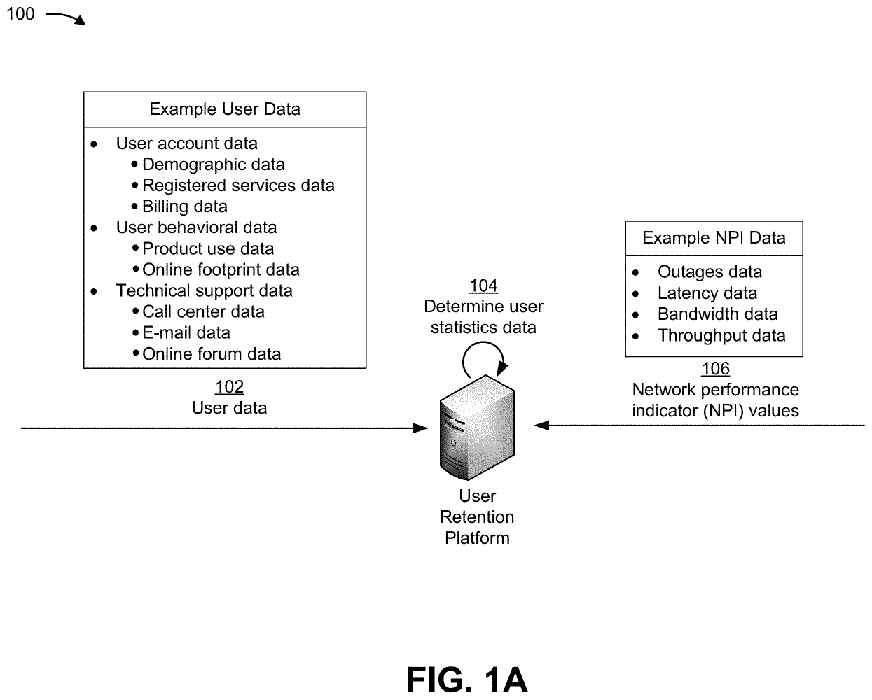

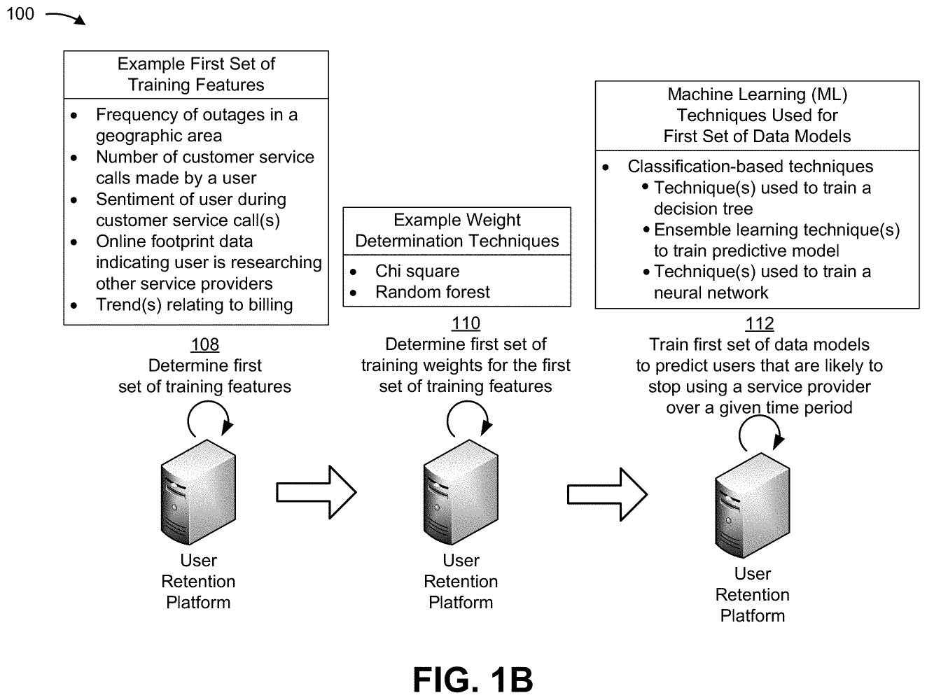

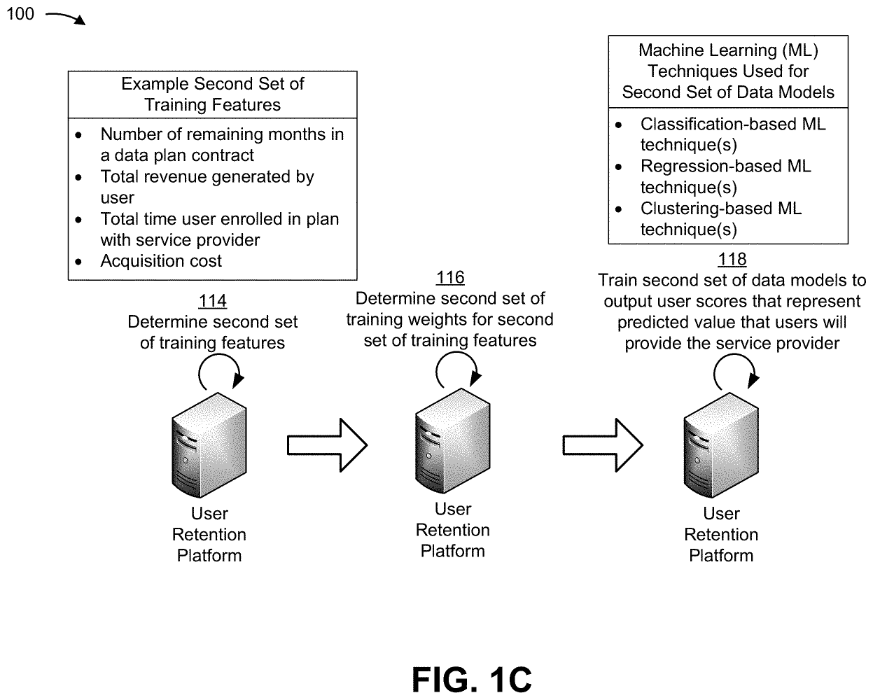

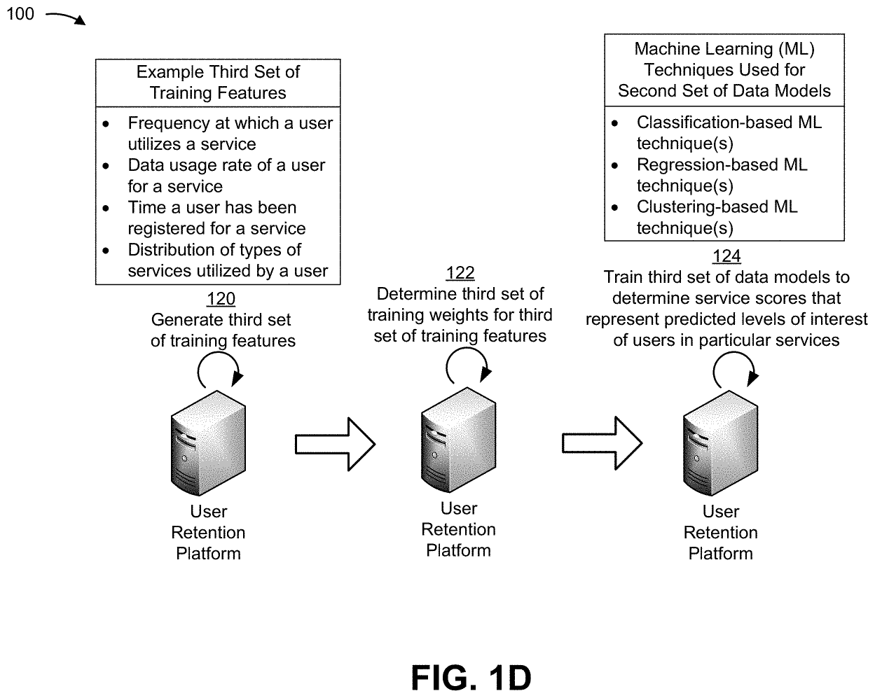

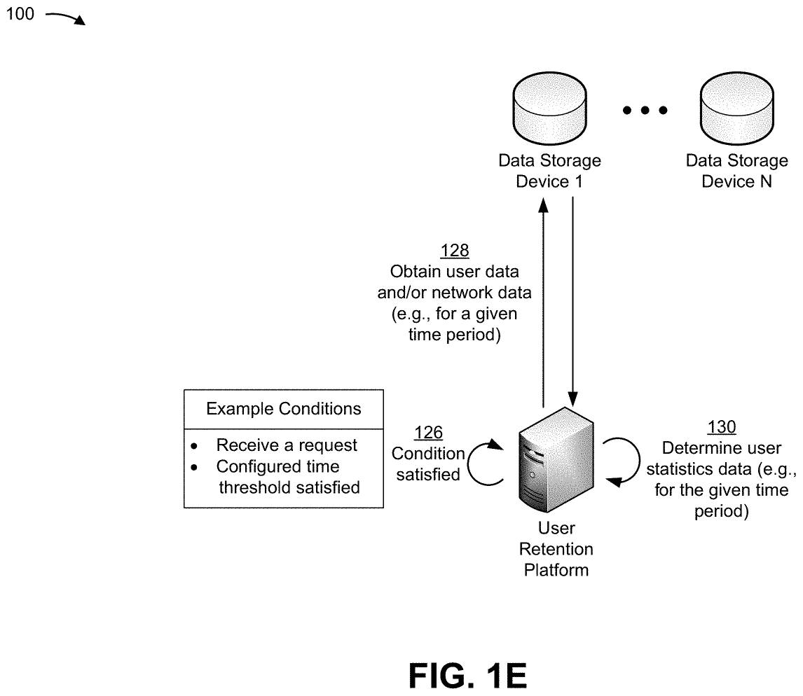

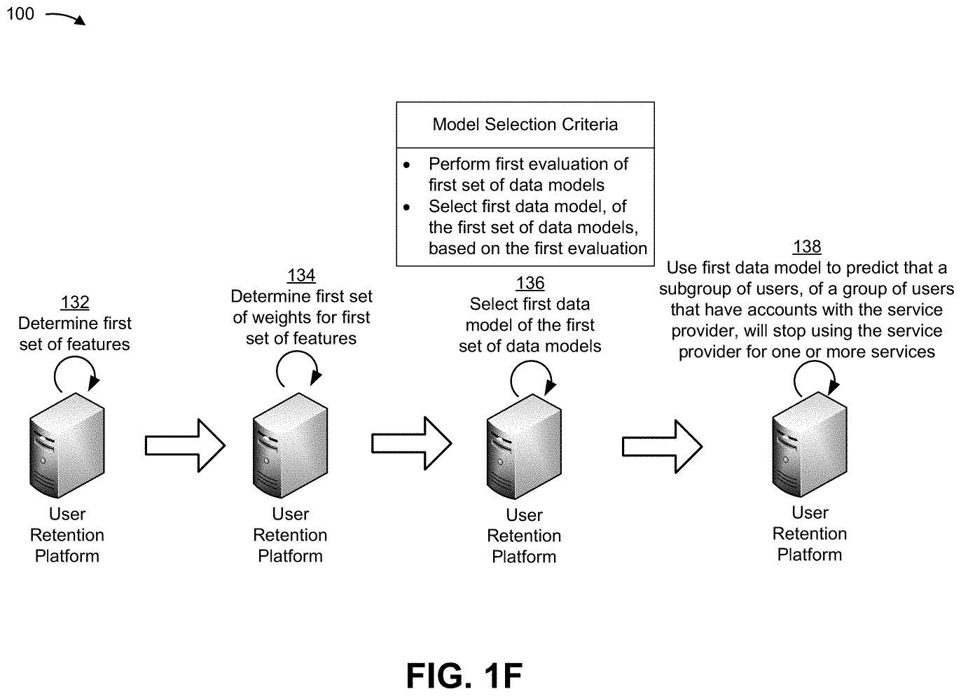

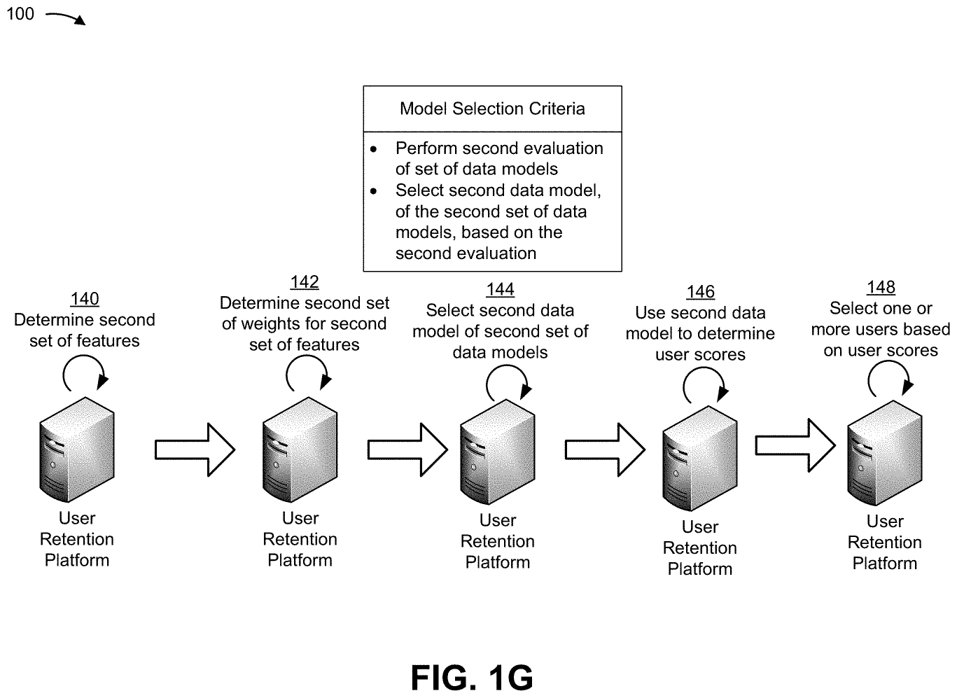

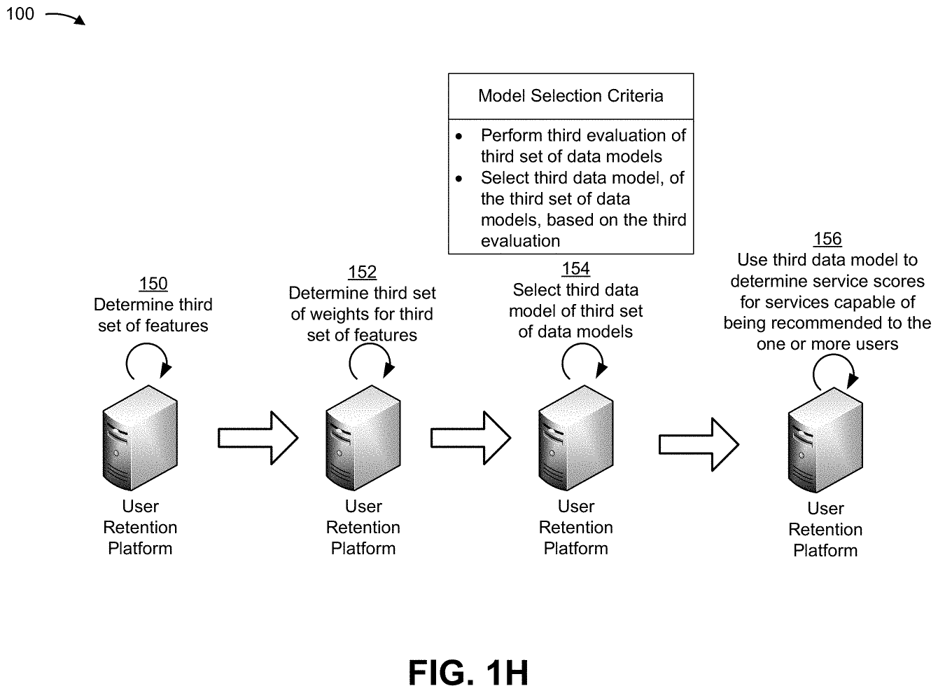

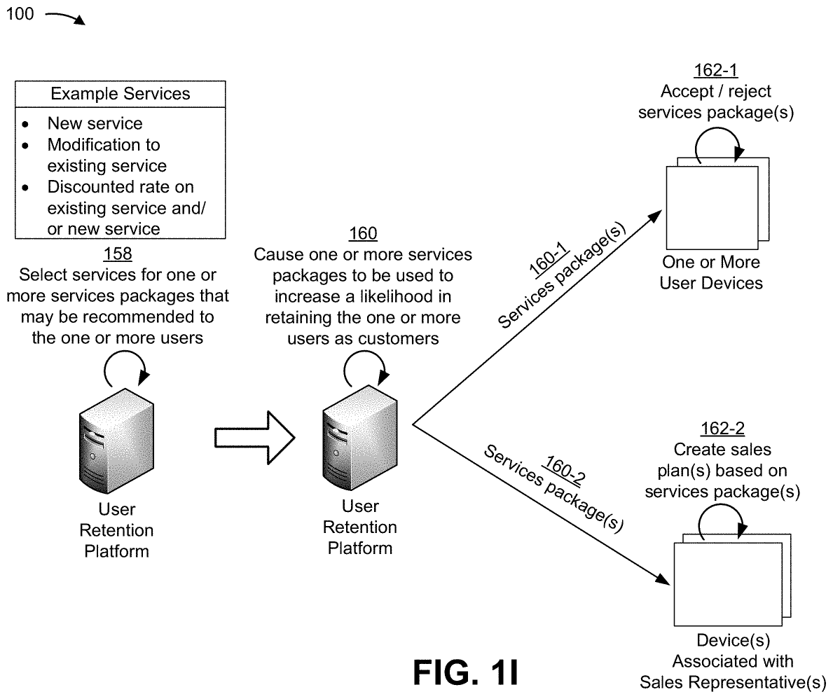

FIGS. 1A-1I are diagrams of one or more example implementations 100 described herein. Example implementation(s) 100 may include a user retention platform, a group of data storage devices (shown as Data Storage Device 1 through Data Storage Device N), one or more user devices, and one or more devices associated with one or more sales representatives.

As shown in FIGS. 1A-1D, the user retention platform may train a first set of data models that are able to predict users who are likely to stop using a service provider for one or more services, a second set of data models that are able to determine value that users will provide to the service provider (e.g., based on revenue generated over time, and/or the like), and a third set of data models that are able to determine predicted levels of interest of users in particular services. As shown in FIGS. 1E-1I, the user retention platform may select particular data models, from the first, second, and third sets of data models and may use the particular data models to identify a group of users who are predicted to stop using the service provider, to identify one or more users from the group as high-value customers, and to provide the one or more users with one or more services packages that include services that are designed to convince the one or more users to continue using the service provider (e.g., instead of switching to a competitor service provider, and/or the like), as described further herein.

A “user” may refer to an individual who is a customer of the service provider, an individual who has an account with the service provider, an individual who uses the service provider for a call service, an individual who uses the service provider for a data service, and/or the like. A “service provider” may refer to a telecommunication service provider, a network service provider, a provider of an application and/or a website that is used over a network, and/or the like. A “service,” as used herein, may be a new service that may be made available to a user, a modification to an existing service, a discounted rate on the new service and/or the existing service, and/or the like. Additionally, it is to be understood that the definition of a service, as used herein, includes transactions involving both tangible and intangible things (such that a service may include providing a user with a product).

One or more implementations described herein refer to data models. For example, one or more implementations refer to a first set of data models, a second set of data models, and a third set of data models. It is to be understood that this is provided by way of example. In practice, other example implementations may be considered. For example, the user retention platform may train a single data model, which may include a first module for performing functionality described in connection with the first set of data models, a second module for performing functionality described in connection with the second set of data models, and a third module for performing functionality described in connection with the third set of data models. Furthermore, one or more data models may be described as being trained using one or more machine learning techniques. In some implementations, the one or more data models may be used for applications driven by artificial intelligence (AI) (in which case, the one or more data models may be referred to as AI data models).

As shown in FIG. 1A, the user retention platform may receive and/or determine data that may be used to train the first, second, and third sets of data models. For example, and as shown by reference number 102, the user retention platform may receive user data. The user data may be for a group of users who have (and/or have had) accounts with the service provider. The user data may include user account data, user behavioral data, technical support data, and/or the like.

The user account data may include demographic data, registered services data, billing data, and/or the like. The demographic data may include data that identifies an age of a user, data that identifies a gender of a user, data that identifies an ethnicity of a user, data that identifies a location associated with a user (e.g., a location based on a billing zip code, a location based on coordinates of a user device associated with a user, and/or the like), data that identifies an occupation of a user, data that identifies a level of education of a user, and/or the like. The registered services data may include data that identifies and/or describes a service to which a user is registered, data that identifies a registration period for a service, data that identifies and/or describes a service to which a user is no longer registered, and/or the like. The billing data may include data that identifies a fee to register for a service, data that identifies a fee to use a service (e.g., a monthly fee, an annual fee, and/or the like), and/or the like.

The user behavioral data may include product use data, online footprint data, and/or the like. The product use data may include data that identifies a service and/or a type of service for which a user has registered (e.g., over a given time period), data that identifies a quantifiable use of a service and/or a type of service (e.g., based on a time spent accessing a service, based on a time that a user has been registered for a service, and/or the like), and/or the like. The online footprint data may include web browsing information, social media information, and/or the like.

The web browsing information may include a set of values indicating online activity for a user, such as a value identifying an internet protocol (IP) address used while browsing webpages, a time value associated with the web browsing, a value identifying a uniform resource locator (URL) for a webpage that has been visited, a value indicating an interactive advertising bureau (IAB) category (e.g., identifying a classification of goods and/or services provided by a particular webpage that has been visited), a value indicating web browsing search terms, a value indicating device information (e.g., a device name, a device operating system, and/or other types of similar device information), a value indicating domain reference information (e.g., identifying a particular domain to which the browsed webpage relates), and/or the like. The social media information may include a value indicating a social media handle (e.g., to identify a particular social media account), a value indicating a social media status, a value associated with a social media feed, a time value associated with the social media feed, a value indicating a date on which the social media account was created, a URL associated with the social media account, one or more values identifying followers of the social media account, one or more values identifying individuals or groups that the social media account is following, and/or the like.

The technical support data may include call center data, electronic mail (e-mail) data, online forum data, and/or the like. The call center data may include data that describes a conversation between a user and a customer service representative (e.g., a human customer service representative, a virtual agent, and/or the like) of the service provider, such as audio data for a recording of a phone conversation, video data for a video recording of a video session, text data for a chat room conversation, and/or the like. The e-mail data may include text data for an e-mail thread describing a conversion between a user and a customer service representative. The online forum data may include data that describes a question, comment, and/or concern provided by a user on a forum, data that describes a customer service representative's response to a question, comment, and/or concern provided by a user on a forum, and/or the like.

In some implementations, the user retention platform may receive user data from a data storage device. For example, the user retention platform may perform a search query to request user data which may cause a data storage device to provide the user data to the user retention platform. As another example, a data storage device may be configured to provide user data to the user retention platform (e.g., automatically, periodically over a threshold time period, based on another type of trigger, and/or the like).

In some implementations, the user retention platform may receive user data from multiple data storage devices. For example, the user retention platform may receive user account data, user behavioral data, and/or technical support data from a first data storage device associated with the service provider. However, the service provider may not have access to certain types of user behavioral data, such as online footprint data. In this case, the user retention platform may obtain the online footprint data from a second data storage device. For example, a third party organization may track an online footprint of a user (e.g., by tracking use of a particular service, by collaborating with a group of organizations to create an online footprint for the user, and/or the like) and may allow the user retention platform to obtain online footprint data for the user (e.g., in exchange for a fee, and/or the like).

As shown by reference number 104, the user retention platform may generate user statistics data for users in the group of users. For example, the user retention platform may generate user statistics data by processing the user data. The user statistics data may include data that identifies an aggregate of particular user data values (e.g., for particular types of user data, for a given time period, for a geographic area, and/or the like), data that identifies an average of the particular user data values, and/or the like. To provide a few specific examples, the user statistics data may include data that identifies fees that a user paid over a given time period, data that identifies a number of calls that a user made in a given time period, data that identifies a total or an average for a particular user data metric for or relating to a group of users (e.g., that share a particular characteristic or type of user data), data that indicates a time of day when a user is most active and/or least active while web browsing, and/or the like.

In some implementations, the user retention platform may determine user statistics data by taking an aggregate and/or an average of particular user data. For example, the user data may include billing data that indicates a monthly fee that a user paid for a particular service. In this case, the user retention platform may process the billing data to determine an aggregate fee that the user pays over a given time period, an average fee that the user paid over the given time period, and/or the like. In some cases, the user retention platform may determine user statistics data by considering multiple types of user data. For example, demographic data may indicate that particular users are within a given age range, and billing data may identify a monthly fee that the particular users pay for a service. In this case, the user retention platform may determine user statistics data that indicates an aggregate fee that the particular users paid over a given time period, an average fee that the particular users paid over the given time period, and/or the like. Additionally, or alternatively, the user retention platform may receive the user statistics data from another source (e.g., from one or more data storage devices that provided the user data, and/or the like).

As shown by reference number 106, the user retention platform may receive a set of network performance indicator (NPI) values. For example, the user retention platform may receive a set of NPI values that measure network performance of a network that is accessible to user devices associated with the group of users.

The set of NPI values may include a first subset of NPI values that identify and/or describe outages within the network, a second subset of NPI values that identify a latency rate, a third subset of NPI values that identify a bandwidth usage rate, a fourth subset of NPI values that identify a throughput rate, and/or the like. For example, the first subset of NPI values may include a value that identifies an outage that occurred within the network, a second value that identifies a location of an outage, a third value that identifies a duration of an outage, a fourth value that identifies a frequency of outages (e.g., over a given time period, in a given geographic area, and/or the like), and/or the like.

In some implementations, the user retention platform may receive the set of NPI values from a data storage device. For example, the user retention platform may receive the set of NPI values from a data storage device associated with the service provider. Additionally, or alternatively, the user retention platform may determine the set of NPI values. For example, if the user retention platform receives NPI values for a geographic region (e.g., a state, a country, and/or the like), the user retention platform may process the NPI values to determine additional NPI values for specific areas within the geographic region (e.g., cities, counties, and/or the like). As another example, if the user retention platform receives NPI values measured over a given time period (e.g., a year, two years, and/or the like), the user retention platform may determine additional NPI values for specific time intervals within the given time period (e.g., weekly, monthly, and/or the like).

In some implementations, the user retention platform may convert the user data and/or the set of NPI values to a uniform format. For example, the user retention platform may receive user data and/or NPI values that have multiple formats. To provide a few examples, the user retention platform may receive data in a text format (e.g., a string format, varchar format, and/or the like), data in a numeric format (e.g., an int, a float, a big int, and/or the like), and/or the like. In this case, the user retention platform may convert the data to a uniform format (e.g., the text format) that may be suitable for further processing.

In this way, the user retention platform receives and/or determines data that will be used to train the first, second, and third sets of data models.

As shown in FIG. 1B, the user retention platform may train the first set of data models. For example, and as shown by reference number 108, the user retention platform may determine a first set of training features that may be used to train the first set of data models. In this case, the user retention platform may perform a set of feature identification techniques to identify an initial set of training features (e.g., ten thousand features, one hundred thousand features, or more) and may use a set of feature determination techniques to process the initial set of training features to determine the first set of training features (e.g., which may include fifty features, one hundred features, or more).

A training feature may be a value (e.g., a numerical value, a character value, a set of character values associated with a word or phrase, and/or the like) that represents a measurable property or characteristic that may be used for training a data model. For example, a feature may be a specific user data value, a specific user statistics data value, a specific NPI value, an aggregate of two or more values, an average of two or more values, a value that serves as a benchmark for a particular type of data and/or particular group of individuals, a value that represents an emotion of a user, a value that represents a level of satisfaction of a user, a combination of two or more values described herein, and/or the like. Specific examples of training features are described in connection with FIGS. 1B-1D.

The first set of training features, for example, may be values that represent properties or characteristics that are indicative of causing and/or contributing to a change (e.g., an increase, a decrease, and/or the like) in a user churn rate of the service provider, properties or characteristics that affect (e.g., increase, decrease, and/or the like) a likelihood that a user will stop using the service provider for one or more services, and/or the like. For example, the first set of training features may include one or more features relating to network outages, such as a feature that indicates when an outage occurred, a feature that indicates a duration of an outage, a feature that indicates a frequency of outages over a given time period, and/or the like. Additionally, or alternatively, and provided as another example, the first set of training features may include one or more features relating to call center data, such as a feature that indicates that a user had a conversation with a customer services representative, a feature that indicates that a user reported an issue and/or filed a complaint relating to a service, a feature that indicates an emotion of a user during a conversation with a customer services representative, a feature that may be indicative of a level of satisfaction of a user before and/or after a conversation with a customer services representative, and/or the like.

Additionally, or alternatively, and provided as another example, the first set of training features may include one or more features relating to online footprint data, such as a feature that indicates that a user has researched other service providers within a threshold time period, a feature that indicates that a user has created a review and/or opinion of the service provider on an online forum, and/or the like. Additionally, or alternatively, and provided as another example, the first set of training features may include one or more features relating to billing data, such as a feature that indicates whether a most recent payment due was made by a user, a feature that indicates whether a payment made by a user was on time, a feature that indicates a trend relating to whether timely payments were made by a user over a given time period, and/or the like.

Additionally, or alternatively, the first set of training features may include one or more other features, such as features associated with aggregates of data and/or values, features associated with averages of data and/or values, combinations of features, and/or the like. For example, one or more features may be identified for a segment of users (e.g., based on a demographic of the users, an income of the users, a geographic area of the users, and/or the like).

In some implementations, the user retention platform may use the set of feature identification techniques to identify the initial set of training features. For example, the user retention platform may identify the initial set of training features using a technique that involves text mining and latent semantic analysis (LSA), a trend variable analysis technique, an interest diversity analysis technique, a technique using a neural network, a composite indicators analysis technique, a clustering technique, and/or the like. In some cases, the user retention platform may identify tens of thousands of features, hundreds of thousands of features, or more, by processing millions, billions, or more, of user data values, user statistics values, and/or NPI values. In this way, the user retention platform may process a quantity of data that cannot be processed objectively by a human actor.

To provide a specific example, the user retention platform may use a trend variable analysis technique to identify features. For example, the user retention platform may execute a trend variable analysis to identify features associated with changes to data over a given time period. In this example, the user retention platform may aggregate values periodically and may compare the aggregated values to identify changes over the given time period. This may allow the user retention platform to identify trends or patterns that may be used as features. As a specific example, the user retention platform may use the trend variable analysis technique to determine that users who historically do not contact customer service representatives, but that contact customer service representatives for two consecutive months, are 20% more likely to stop using one or more services of the service provider, and users who contact customer service representatives for three consecutive months are 50% more likely to stop using one or more services of the service provider. This may allow the user retention platform to store the trend as a feature.

In some implementations, the user retention platform may use the set of feature determination techniques to determine the first set of training features. For example, the user retention platform may determine the first set of training features with a wrapper technique, a filter technique (e.g., a technique using a relief analysis, such as a variable selection using random forest (VSURF) analysis, and/or the like), an embedded technique (e.g., a technique using a bootstrapping analysis, a dimensionality reduction technique, such as a technique using a principal component analysis (PCA), and/or the like), and/or the like. Additional feature determination techniques may be used to weight particular features, which will be described further herein.

To provide a specific example, the user retention platform may perform a VSURF analysis. For example, the user retention platform may perform the VSURF analysis to sort the initial set of training features into a number N of subsets of training features. Additionally, the user retention platform may process each of the N subsets of training features using random forests that include decision trees, where the decision trees identify a level of importance of each feature. This may allow the user retention platform to determine that particular features, that satisfy a threshold level of importance, are to be included in the first set of training features.

In some implementations, the user retention platform may determine one or more features, of the first set of training features, using one or more natural language processing techniques and/or feature determination techniques. For example, the user retention platform may determine one or more features that indicate an emotion and/or a level of satisfaction of a user during a conversation with a customer services representative. The conversation between the user and the customer services representative may be captured using a file, such as a video file, an audio file, and/or a text file, depending on a technology medium used to have the conversation.

If the file is a text file, the user retention platform may first use a set of natural language processing techniques to process the text file to generate conversation metadata for the conversation. For example, the user retention platform may process the text file using a matching technique (e.g., a fuzzy matching technique, and/or the like), a syntax-based processing technique (e.g., a parts of speech (PoS) tagging technique, a lemmatization technique, and/or the like), and/or the like, to generate the conversation metadata. The conversation metadata may include data that identifies a time at which the conversation was made, data that identifies one or more parties to the conversation, data that identifies a medium used for the conversation, and/or the like.

Continuing with the example, the user retention platform may use a set of semantic-based processing techniques to determine the emotion and/or level of satisfaction of the user during the conversation. For example, the user retention platform may use a sentiment analysis technique, a named entity recognition (NER) technique, and/or the like, to determine the emotion and/or the level of satisfaction of the user. To provide a specific example, the user retention platform may use a sentiment analysis technique to determine a polarity of text provided by the user, such that specific terms in the text may be scored as having a positive polarity, a neutral polarity, or a negative polarity. The sentiment analysis technique may, for example, associate a sentence comprised largely of terms with a positive polarity as the user having a positive opinion, and/or may associate a sentence comprised largely of terms with negative polarity as the user having a negative opinion. In this case, the user retention platform may use one or more feature determination techniques to determine that data describing the emotion and/or the level of satisfaction of the user is to be used as one or more features.

As another example, if the file is an audio file, the user retention platform may first perform an audio-to-text conversion technique to convert audio data to text data. This may allow the user retention platform to use the set of natural language processing techniques and/or the one or more feature determination techniques described above to determine the one or more features.

As another example, if the file is a video file, the user retention platform may first perform the audio-to-text conversion technique to convert audio data to text and may use the set of natural language processing techniques and the one or more feature determination techniques to determine the one or more features. Additionally, if the file is the video file, the user retention platform may determine one or more additional features that indicate a body language of the user, a gesture made by the user, and/or the like. For example, the user retention platform may use an object recognition technique to process a set of frames of the video to identify the user within each frame. In this case, the user retention platform may use a set of image processing techniques, such as an image matching technique, to compare pixels that identify the user to pixels associated with other users who are known to be making a particular body movement or gesture. This may allow the user retention platform to determine the one or more additional features.

As shown by reference number 110, the user retention platform may determine a first set of training weights for the first set of training features. For example, particular features of the first set of training features may be stronger (and/or weaker) indicators of causing or contributing to a change in a user churn rate and/or may be stronger (and/or weaker) indicators affecting a likelihood that a user will stop using the service provider for one or more services. In this case, the user retention platform may determine the first set of training weights and may assign the first set of training weights to the first set of training features (which may be referred to herein as a first set of weighted training features). The user retention platform may use the first set of weighted training features to train the first set of data models, as described further herein.

In some implementations, the user retention platform may use one or more feature weighting techniques to determine the first set of weighted training features. For example, the user retention platform may determine the first set of weighted training features using a random forest, a chi square test, and/or the like. To provide an example, the user retention platform may determine one or more weighted training features using a chi square test. In this example, the user retention platform may use the chi square test to determine a relationship between one or more values and one or more predicted outcomes. As a specific example, the user retention platform may determine that a set of ten features are indicators that a user is likely to stop using the service provider for a service. The user retention platform may be able to use the chi square test to determine relationships between the ten features and the likelihoods of those features being associated with an outcome with the user stops using the service provider for the service. In this example, the user retention platform may be able to assign weighted values to the ten features, based on the relationships between each respective feature and the outcome.

As another example, the user retention platform may determine one or more weighted training features using a random forest. In this example, the user retention platform may train a random forest that includes a set of decision trees (e.g., classification trees, decision trees, and/or the like). To train the random forest, the user retention platform may provide input values to each decision tree and may assign weighted values to combinations of input values based on likelihoods that the combinations produce particular outcomes. The user retention platform may iteratively update the weighted values as new input values are provided to the random forest.

As shown by reference number 112, the user retention platform may train the first set of data models to predict users who are likely to stop using a service provider over a given time period. For example, the user retention platform may train the first set of data models by using a first set of machine learning techniques to process the first set of weighted training features, the user data, the user statistics data, the set of NPI values, and/or the like. The first set of machine learning techniques may include classification-based techniques, such as one or more techniques used to train a decision tree, one or more ensemble learning techniques used to train a predictive model, one or more techniques used to train a neural network, and/or the like.

In some implementations, the user retention platform may train the first set of data models using the first set of weighted training features. For example, the user retention platform may use the first set of weighted training features to train multiple data models, such as by training decision trees, predictive models, neural networks, and/or the like. By training multiple data models, the user retention platform is able to select an optimal data model to use, from the multiple data models, thereby conserving resources by reducing sparsity and overfitting relative to using a less optimal data model, as described further herein.

As an example, the user retention platform may use the first set of weighted training features to train a data model. For example, the user retention platform may use the random forest described elsewhere herein as a data model of the first set of data models.

As another example, the user retention platform may use the first set of weighted training features to train a neural network. In this example, the user retention platform may train a neural network that has an input layer, one or more intermediate layers (e.g., a fully connected layer, a convolutional layer, a pooling layer, a recurrent layer, and/or the like), and an output layer. For example, the first set of weighted training features may be hyperparameters that are used as part of a cost function of the neural network. In this case, the user retention platform may perform a feedforward technique to provide particular values as input to the neural network, and the neural network may output user churn scores that indicate likelihoods of users discontinuing one or more services with the service provider. The user churn scores may be based on the first set of weighted training features. Additionally, the user retention platform may compare the user churn scores to known values and may determine an error value based on the comparison between the user churn scores and the known values. The error value may be used to update the first set of weighted training features, and the user retention platform may perform a backpropagation technique to iteratively train the neural network until a threshold level of accuracy has been reached.

In some implementations, the user retention platform may train one or more data models, of the first set of data models, to predict that a user is likely to stop using the service provider at specified time periods. For example, the user retention platform may train a data model such that the data model is able to output separate sets of prediction values for each specified time period. As an example, the user retention platform may train a data model to output a first set of prediction values that indicate likelihoods that a user stops using the service provider in one month, to output a second set of prediction values that indicate likelihoods that the user stops using the service provider in two months, and to output a third set of prediction values that indicate likelihoods that the user stops using the service provider in three months, where the one month, two months, and three months are time periods that may be configured by permitted users (e.g., employees of the service provider who are using the data models).

In this way, the user retention platform trains the first set of data models to identify users who are likely to stop using the service provider for one or more services.

As shown in FIG. 1C, the user retention platform may train the second set of data models. For example, and as shown by reference number 114, the user retention platform may determine a second set of training features that may be used to train the second set of data models. In this case, the user retention platform may have already determined the initial set of training features, as described above, and may use one or more feature determination techniques, of the set of feature determination techniques, to process the initial set of training features to determine the second set of training features (e.g., which may include fifty features, one hundred features, or more).

The second set of training features, for example, may be values that represent properties or characteristics that are indicative of a value (e.g., a positive value, a negative value, and/or the like) that a user provides and/or will provide to the service provider over a given time period. For example, the second set of training features may include one or more features relating to billing, such as a feature that indicates an amount of revenue that a user provided to the service provider over a given time period, a feature that indicates an average amount of revenue that a user provided to the service provider over a given time period, a feature that indicates a total amount of revenue that a user provided to the service provider, a feature that indicates whether one or more payments made by a user over a given time period were timely payments, a feature that indicates a ratio of timely payments to late payments over a given time period, a feature that indicates a cost to acquire the user as a customer, and/or the like.

Additionally, or alternatively, and provided as another example, the second set of training features may include other features that impact value provided to the service provider, such as a feature that indicates a publicly accessible review of the service provider that was created by a user (e.g., a positive review, a negative review, and/or the like), a feature that indicates an opinion of a user as input to a survey, and/or the like. Additionally, or alternatively, and provided as another example, the second set of features may include features that add value by way of customer loyalty, such as a feature that indicates a total time that a user has been a customer of the service provider, and/or the like.

Additionally, or alternatively, and provided as another example, the second set of features may include features that are indicative of value added based on network consumption, such as a feature that indicates an amount of data usage for a user during a given time period, a feature that indicates an amount of data usage for a user during a given time period relative to an average amount of data usage, a feature that indicates an amount of data usage for a user during a given time period relative to an amount of revenue that the user provided the service provider, and/or the like. Additionally, or alternatively, the second set of training features may include one or more other features, such as features associated with aggregates of data and/or values, features associated with averages of data and/or values, combinations of features, and/or the like.

In some implementations, the user retention platform may determine the second set of training features using one or more feature determination techniques of the set of feature determination techniques. A description of the one or more feature determination techniques is provided in connection with FIG. 1B.

As shown by reference number 116, the user retention platform may determine a second set of training weights for the second set of training features. For example, particular features of the second set of training features may be stronger (and/or weaker) indicators of a value that a user provides to the service provider over a given time period. In this case, the user retention platform may use the one or more feature weighting techniques (as described elsewhere herein) to determine the second set of training weights and to assign the second set of training weights to the second set of training features (referred to herein as a second set of weighted training features). The user retention platform may use the second set of weighted training features to train the second set of data models, as described below.

As shown by reference number 118, the user retention platform may train the second set of data models to output user scores that represent values that users are predicted to provide to the service provider. For example, the user retention platform may train the second set of data models by using a second set of machine learning techniques to process the second set of weighted training features, the user data, the user statistics data, the NPI values, and/or the like. The second set of machine learning techniques may include one or more classification-based techniques (e.g., as described above), one or more regression-based techniques, one or more clustering-based techniques, and/or the like.

In some implementations, the user retention platform may train the second set of data models using the second set of weighted training features. For example, the user retention platform may use the second set of weighted training features to train multiple data models, such as by training a data model using a classification-based technique (as described above), by training a data model using a regression-based technique (e.g., a regression tree, a mixed model, a data model trained using a linear regression technique, and/or the like), by training a data model using a clustering-based technique (e.g., a connectivity model, a distribution model, a graph-based model, and/or the like), and/or the like. By training multiple data models, the user retention platform is able to select an optimal data model to use, from the multiple data models, thereby conserving resources by reducing sparsity and overfitting relative to using a less optimal data model.

In some implementations, the user retention platform may train the second set of data models to predict an overall lifetime score for a user. For example, the user retention platform may train the second set of data models to predict, based on a given set of input data, an overall lifetime score that represents a value that a user will provide to the service provider throughout the user's lifetime.

In this way, the user retention platform trains the second set of data models to predict value that users will provide to the service provider.

As shown in FIG. 1D, the user retention platform may train the third set of data models. For example, and as shown by reference number 120, the user retention platform may determine a third set of training features that may be used to train the third set of data models. In this case, the user retention platform may have already determined the initial set of training features, as described above, and may use one or more feature determination techniques, of the set of feature determination techniques, to process the initial set of training features to determine the third set of training features (e.g., which may include fifty features, one hundred features, or more).

The third set of training features, for example, may be values that represent properties or characteristics that are indicative of a level of interest of a user in one or more services of the service provider. For example, the third set of training features may include one or more features relating to user behavioral data, such as one or more features relating to usage of a service, one or more features relating to purchasing habits of a user, one or more features relating to an online footprint of a user, and/or the like. As an example, the one or more features relating to usage of a service, which may serve as indicators of a level of interest of a user in a service, may include a feature that indicates a frequency at which a user accesses a service, a feature that indicates a data usage rate for a user associated with a service, a feature that indicates particular times of day at which a user accesses a service, and/or the like.

As another example, the one or more training features relating to the purchasing habits of a user, which may serve as indicators of a level of interest of the user in a service, may include a feature that indicates a total time at which a user has been registered for a service, a feature that indicates a type or genre of a service or a group of services to which a user is registered, a feature that indicates a pattern or habit associated with removing and/or stopping usage of a service, and/or the like. As another example, the one or more features relating to the online footprint of a user, which may serve as indicators of a level of interest of the user in a service, may include a feature that indicates a type of website or forum that a user visits, a feature that indicates a frequency at which the user visits the website or the forum, and/or the like.

Additionally, or alternatively, and provided as another example, the third set of training features may include one or more features relating to user account data, such as one or more features relating to demographic data of a user. As an example, the one or more features relating to demographic data of a user, which may serve as indicators of a level of interest of a user in one or more services, may include a feature that indicates a trend that a certain type of demographic is interested in a service, a feature that indicates that a certain type of demographic is not interested in a service, and/or the like.

Additionally, or alternatively, and provided as another example, the third set of training features may include one or more features relating to technical support data, such as one or more features relating to a conversation that a user had with a customer service representative. As an example, the one or more features relating to the conversation may include a feature that indicates an emotion of a user, a feature that indicates a satisfaction level of a user, a feature that indicates a body movement or gesture of a user, and/or the like. Additionally, or alternatively, and provided as another example, the third set of training features may include one or more features that indicate one or more combinations of features, one or more averages of other features, one or more aggregate totals of other features, and/or the like.

One or more implementations described herein provide specific examples of features. It is to be understood that these specific examples are illustrative, and that in practice, any number of other features may be utilized. For example, other features may be utilized that are indicative of causing and/or contributing to a change in a user churn rate, other features that are indicative of contributing to a value that a user provides to the service provider, other features that are indicative of a level of interest of a user in a particular service, and/or the like.

As shown by reference number 122, the user retention platform may determine a third set of training weights for the third set of training features. For example, particular features of the third set of training features may be stronger (and/or weaker) indicators of a level of interest that a user has in one or more services. In this case, the user retention platform may use the one or more feature weighting techniques (as described elsewhere herein) to determine the third set of training weights and to assign the third set of training weights to the third set of training features (referred to herein as a third set of weighted training features). The user retention platform may use the third set of weighted training features to train the third set of data models, as described below.

As shown by reference number 124, the user retention platform may train the third set of data models to output service scores that represent predicted levels of interest of users in particular services. For example, the user retention platform may train the third set of data models by using a third set of machine learning techniques to process the third set of weighted training features, the user data, the user statistics data, and/or the set of NPI values. The third set of machine learning techniques may include one or more classification-based techniques, one or more regression-based techniques, one or more clustering-based techniques, and/or the like.

In some implementations, the user retention platform may train the third set of data models using the third set of weighted training features. For example, the user retention platform may use the third set of weighted training features to train multiple data models, such as by training a data model using a classification-based technique (as described above), by training a data model using a regression-based technique (e.g., a linear regression technique, a regression tree, a mixed model, and/or the like), by training a data model using a clustering-based technique (e.g., a connectivity model, a distribution model, a graph-based model, and/or the like), and/or the like. By training multiple data models, the user retention platform is able to select an optimal data model to use, from the multiple data models, thereby conserving resources by reducing sparsity and overfitting relative to using a less optimal data model.

In this way, the user retention platform trains the third set of data models to determine user scores that represent predicted levels of interest of users in particular services.

As shown in FIG. 1E, and by reference number 126, the user retention platform may determine that a condition is satisfied. For example, the user retention platform may determine whether a condition is satisfied that causes the user retention platform to use the first, second, and/or third set of data models to determine whether to offer additional services to particular users, of the group of users who have accounts with the service provider. The condition that causes the user retention platform to determine whether to offer the additional services may be a request, may be related to a configured time period, and/or another type of configurable rule. The condition may be satisfied when the user retention platform receives the request, when the configured time period has passed and/or when a current time period matches the configured time period, and/or the like.

In some implementations, the user retention platform may determine that the condition is satisfied based on receiving a request. For example, a user retention management application and/or a user retention management website may have a front-end user interface that allows employees and/or agents of the service provider to submit requests to the user retention platform. As a specific example, an employee may use a user device to access the front-end user interface to submit a request that specifies a group of users to target (e.g., users within a particular state, particular country, and/or the like), that specifies a time or set of times at which to determine whether to offer additional services to the specified group of users, and/or the like.

Additionally, or alternatively, the user retention platform may be configured to determine whether to offer additional services to a group of users at particular time periods. For example, the user retention platform may be configured to make the determination once a week, once a month, once every three months, and/or the like. Additionally, the user retention platform may be configured with other time data that specifies a time frame at which to obtain user data and/or NPI values that will be used to make the determination (e.g., by obtaining data for the past one month, past three months, and/or the like).

As shown by reference number 128, the user retention platform may, based on the condition being satisfied, obtain user data and/or NPI values. For example, the user retention platform may obtain, from the group of data storage devices, user data and/or NPI values for a given time period (e.g., for the past one month, past three months, and/or the like).

As shown by reference number 130, the user retention platform may determine user statistics data. For example, the user retention platform may determine user statistics data for the given time period, in a manner described elsewhere herein. The user data, the NPI values, and/or the user statistics data are defined in connection with FIG. 1A.

In this way, the user retention platform receives and/or determines data that may be further processed by one or more data models, of the first, second, and third sets of data models, as described further herein.

As shown in FIG. 1F, the user retention platform may use a first data model, of the first set of data models, to predict that a group of users will stop using the service provider for one or more services. For example, and by reference number 132, the user retention platform may determine a first set of features that may be processed by the first set of data models. In this case, the user retention platform may perform the set of feature identification techniques to determine an initial set of features, and may use the set of feature determination techniques to process the initial set of features to determine the first set of features. The initial set of features may include one or more features described in connection with the initial set of training features. The first set of features may include one or more features described in connection with training features (e.g., the first set of training features, and/or the like).

As shown by reference number 134, the user retention platform may determine a first set of weights for the first set of features. For example, the user retention platform may use the one or more feature weighting techniques, as described elsewhere herein, to determine the first set of weights and to assign the first set of weights to the first set of features (referred to herein as a first set of weighted features).

As shown by reference number 136, the user retention platform may select a first data model of the first set of data models. For example, the first set of data models may produce output values with varied levels of accuracy. Additionally, a data model may be more, or less, accurate (relative to other data models in the first set of data models) based on a configured time at which to predict that users will stop using the service provider. As a specific example, a first data model may be more accurate than a second data model for predicting which users will stop using the service provider in one month, but the second data model may be more accurate than the first data model for predicting which users will stop using the service provider in three months. Therefore, the user retention platform may perform a first evaluation of the first set of data models and may select a first data model, of the first set of data models, as a data model that is to be used to predict, for a given time period, which users will stop using the service provider.

One or more implementations described herein involve evaluations. For example, the user retention platform may perform the first evaluation on the first set of data models, may perform a second evaluation on the second set of data models (as described in connection with FIG. 1G), and may perform a third evaluation on the third set of data models (as described in connection with FIG. 1H). An evaluation (e.g., the first, second, and/or third evaluation) may include a set of tests, such as a normality test, a test to measure multicollinearity, a test to measure logarithmic loss, a test using a confusion matrix, a sampling test (e.g., that compares outputs that a data model outputs using training data and outputs associated with test data), a test to measure error (e.g., a mean error, a means squared error, and/or the like), and/or the like.

As an example, the user retention platform may perform a normality test on the first set of data models. In this example, the user retention platform may perform a normality test by comparing a histogram of training data associated with a data model and a normal probability distribution. If the histogram of the training data is similar to the normal probability distribution, the normality test may output one or more values that indicate that the data model is producing accurate results. If the histogram of the training data is not similar to the normal probability distribution, the normality test may output one or more values that indicate that the data model is not producing accurate results. This may allow the user retention platform to select a data model, of the first set of data models, that is associated with a histogram that has a threshold degree of similarity to the normal probability distribution (e.g., a highest degree of similarity relative to other data models in the first set of data models).

In some implementations, the user retention platform may select the first data model before the condition is satisfied. For example, the user retention platform, after training the first set of data models, may perform the first evaluation during a testing phase to identify the first data model as the data model that will be used to predict which users will stop using the service provider. As an example, the user retention platform may generate a confusion matrix that indicates a ratio of correct predictions to a total number of predictions. To generate the confusion matrix, the user retention platform may have training data (e.g., particular user data, particular NPI values, and/or the like) and test data that includes expected outcome values. In this case, the user retention platform may, for each data model, of the first set of data models, process the training data to generate output values. Additionally, the user retention platform may compare the output values and the expected outcome values and generate confusion matrix values based on the comparison. This may allow the user retention platform to select a data model, of the first set of data models, that has a confusion matrix with high number of correct predictions and/or a low number of incorrect predictions (relative to other data models in the first set of data models).

By selecting the first data model, of the first set of data models, as described herein, the user retention platform conserves resources (e.g., processing resources, network resources, memory resources, and/or the like) that would otherwise be wasted by using another data model, of the first set of data models, to process the input data (which may produce inaccurate and/or suboptimal results relative to the first data model).

In some implementations, one or more new data models may be generated over time. For example, the user retention platform may, over time, generate one or more new data models that may be included in the first set of data models. When a new data model is added to the first set of data models, the user retention platform may re-perform the first evaluation and may re-select a best-fit data model of the first set of data models.

As shown by reference number 138, the user retention platform may use the first data model to predict that a subgroup of users, of a group of users who have accounts with the service provider, will stop using the service provider for one or more services. For example, the user retention platform may provide, as input to the first data model, the first set of weighted features, the user data, the NPI values, and/or the user statistics data (collectively referred to as input data). This may cause the first data model to output a set of churn scores that indicate, for each user in the group of users, a likelihood that a user will stop using the service provider for one or more services in a given time period.

In some implementations, the user retention platform may, based on the set of churn scores, predict that a subgroup of users, of the group of users, will stop using the service provider for services. For example, the user retention platform may be configured with a threshold confidence score and may predict that a user will stop using the service provider in the given time period based on the user being associated with a churn score that satisfies the threshold confidence score.

In this way, the user retention platform uses the first data model to identify the subgroup of users who are predicted to stop using the service provider for one or more services in the given time period.

As shown in FIG. 1G, the user retention platform may use a second data model, of the second set of data models, to determine a set of user scores that represent value that the subgroup of users provides to the service provider and may select one or more users, of the subgroup of users, based on the set of user scores. For example, and as shown by reference number 140, the user retention platform may determine a second set of features. In this case, the user retention platform may have already determined the initial set of features, as described above, and may use one or more feature determination techniques, of the set of feature determination techniques, to process the initial set of features to determine the second set of features. The second set of features may include one or more features described in connection with the second set of training features.

As shown by reference number 142, the user retention platform may determine a second set of weights for the second set of features. For example, the user retention platform may use the one or more feature weighting techniques, as described elsewhere herein, to determine the second set of weights and to assign the second set of weights to the second set of features (referred to herein as a second set of weighted features).

As shown by reference number 144, the user retention platform may select a second data model of the second set of data models. For example, the second set of data models may produce output values with varied levels of accuracy. Therefore, the user retention platform may perform a second evaluation on the second set of data models and may select a second data model, of the second set of data models, as a data model that is to be used for generating user scores for the subgroup of users. The second evaluation may include one or more tests that are identified in the description of FIG. 1F.

As an example, the user retention platform may perform a test to measure multicollinearity. In this example, a data model may have been trained using one or more regression techniques and the user retention platform may test the data model by measuring multicollinearity. To measure multicollinearity, the user retention platform may measure changes in estimated regression coefficient values given different input values. An estimated regression coefficient value may represent a relationship between a feature or a set of features and a given output. The user retention platform may select the second data model, of the second set of data models, based on the second data model processing estimated regression coefficient values that satisfy a threshold confidence value (relative to other data models of the second set of data models).

By selecting the second data model, of the second set of data models, as described herein, the user retention platform conserves resources (e.g., processing resources, network resources, memory resources, and/or the like) that would otherwise be wasted by using another data model, of the second set of data models, to process the input data (which may produce inaccurate and/or suboptimal results relative to the second data model).

As shown by reference number 146, the user retention platform may use the second data model to determine a set of user scores that represent value that the subgroup of users provide to the service provider. For example, the user retention platform may provide, as input to the second data model, the second set of weighted features, the user data, the NPI values, and/or the user statistics data (collectively referred to as input data). This may cause the second data model to output the set of user scores.

As shown by reference number 148, the user retention platform may select one or more users, of the first subgroup of users, based on the set of user scores. For example, the user retention platform may be configured with a threshold confidence score and may select a user based on a user score associated with the user satisfying the threshold confidence score.

In some implementations, the user score may represent an overall lifetime score that a user is predicted to provide to the service provider. In this case, the user retention platform may select one or more users, of the subgroup of users, that have an overall lifetime score that satisfies a threshold confidence score.

In this way, the user retention platform uses the second data model to identify one or more users who have a high worth to the service provider (e.g., relative to other users with lower user scores) and who may be provided with additional services to attempt to retain the one or more users as customers, as described further herein.

As shown in FIG. 1H, the user retention platform may use a third data model, of the third set of data models, to determine a set of service scores that represent a predicted level of interest of users in a set of services of the service provider. For example, and as shown by reference number 150, the user retention platform may determine a third set of features. In this case, the user retention platform may have already determined the initial set of features, as described above, and may use the set of feature determination techniques to process the initial set of features to determine the third set of features. The third set of features may include one or more features described in connection with training features (e.g., the third set of training features, and/or the like).

As shown by reference number 152, the user retention platform may determine a third set of weights for the third set of features. For example, the user retention platform may use the one or more feature weighting techniques, as described elsewhere herein, to determine the third set of weights and to assign the third set of weights to the third set of features (referred to herein as a third set of weighted features).

As shown by reference number 154, the user retention platform may select a third data model of the third set of data models. For example, the third set of data models may produce output values with varied levels of accuracy. Therefore, the user retention platform may perform a third evaluation on the third set of data models and may select a third data model, of the third set of data models, as a data model that is to be used for determining the set of service scores for the services that are capable of being recommended to the one or more users. The third evaluation may include one or more tests defined elsewhere herein.

By selecting the third data model, of the third set of data models, as described herein, the user retention platform conserves resources (e.g., processing resources, network resources, memory resources, and/or the like) that would otherwise be wasted by using another data model, of the third set of data models, to process the input data (which may produce inaccurate and/or suboptimal results relative to the third data model).

As shown by reference number 156, the user retention platform may use the third data model to determine the set of service scores for the services that are capable of being recommended to the one or more users. For example, the user retention platform may provide, as input to the third data model, the third set of weighted features, the user data, the NPI values, and/or the user statistics data (collectively referred to as input data). This may cause the third data model to output the set of service scores.

In this way, the user retention platform determines the set of scores, which may be used to select one or more services to recommend to the one or more users, as described further herein.

As shown in FIG. 11, and by reference number 158, the user retention platform may select services for one or more services packages that may be recommended to the one or more users. For example, the user retention platform may select, for each user of the one or more users, a services package that includes one or more services. The services package may include an offer for one or more new services to be provided to a user, an offer to modify existing services that are presently being provided to a user, an offer to provide a user with a discounted rate on a new service and/or an existing service, and/or the like.

To provide an illustrative example, the group of users may include 10,000 users. In this example, the user retention platform may, using the first data model, identify 500 users who are predicted to stop using one or more services within the next month. Additionally, the user retention platform may, using the second data model, determine user scores for each of the 500 users. In this case, the user retention platform may select 100 users, of the 500 users, that have a user score that satisfies a threshold confidence score. Furthermore, the user retention platform may use the third data model to determine, for each of the 100 users, a set of service scores for a set of 50 available services that may be offered to the 100 users. In this case, each service score may represent a predicted level of interest of a user in a particular service and may be based on specific characteristics of the users, such as demographic information for a user, spending habits of a user, likes or dislikes as may have been identifiable via data usage of a user and/or an online footprint left by a user, and/or the like. Moreover, the user retention platform may select particular services for each of the 100 users based on each respective set of service scores.

As shown by reference number 160, the user retention platform may perform one or more actions to cause the one or more services packages to be used to increase a likelihood of retaining the one or more users as customers. For example, and as shown by reference number 160-1, the user retention platform may provide the one or more services packages to the one or more user devices. In this case, the user retention platform may provide the one or more services packages using a communication interface, such as an application programming interface (API) and/or another type of communication interface. As shown by reference number 162-1, this may permit the one or more user devices to accept or reject the one or more services packages.

Additionally, or alternatively, the user retention platform may provide the one or more services packages to accounts of the one or more users. For example, the user retention platform may provide a services package to an e-mail account of a user, an account for an application or a website associated with the services provider, and/or the like.

As shown by reference number 160-2, the user retention platform may provide the one or more services packages to the one or more devices associated with the one or more sales representatives. The user retention platform may provide the one or more services packages via an API and/or another type of communication interface. As shown by reference number 162-2, this may permit the one or more devices associated with the one or more sales representatives to create one or more sales plans based on the one or more services packages. For example, a device associated with a sales representative may display a services package for a user and a sales representative may, based on the services package and/or a user profile of the user, create a sales plan that is designed to retain the user as a customer of the service provider.

In some implementations, the user retention platform may use feedback data to retain one or more data models described herein. For example, the user retention platform may receive feedback data from a user that indicates whether the user enjoyed a services package, whether particular services in the services package align with interests of the user, whether the services package prevented the user from switching to a competitor services provider, and/or the like. In this case, the user retention platform may use the feedback data to retrain the third set of data models, thereby improving overall accuracy of each respective model.

Additionally, or alternatively, the user retention platform may generate a report that includes quantifiable metrics that measure an effectiveness of the one or more services packages. For example, the user retention platform may generate a report that includes a metric that indicates a number of users, of the one or more users, who continued to use the service provider after a period during which those users were predicted to leave the service provider, a metric that indicates whether a user has, for a particular time period, provided a value to the service provider that is similar to a value that the user was predicted to provide to the service provider, a metric that indicates a number of users who accepted a services package, and/or the like. The quantifiable metrics may be used to retrain one or more data models described herein, thereby improving overall accuracy of each respective model.

In this way, the user retention platform causes the one or more services packages to be used to increase a likelihood of retaining the one or more users who have been identified as high-value customers to the service provider.

As indicated above, FIGS. 1A-1I are provided merely as one or more examples. Other examples may differ from what is described with regard to FIGS. 1A-1I. For example, there may be additional devices and/or networks, fewer devices and/or networks, different devices and/or networks, or differently arranged devices and/or networks than those shown in FIGS. 1A-1I. Furthermore, two or more devices shown in FIGS. 1A-1I may be implemented within a single device, or a single device shown in FIGS. 1A-1I may be implemented as multiple and/or distributed devices. Additionally, or alternatively, a set of devices (e.g., one or more devices) included in the one or more example implementations 100 may perform one or more functions described as being performed by another set of devices included in the one or more example implementations 100.

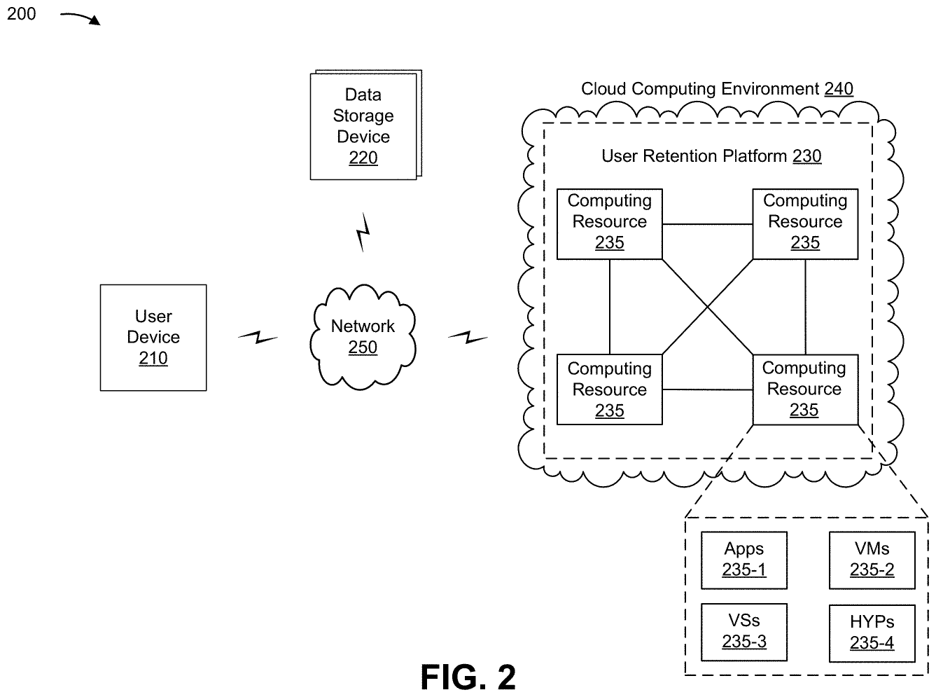

FIG. 2 is a diagram of an example environment 200 in which systems and/or methods described herein may be implemented. As shown in FIG. 2, environment 200 may include a user device 210, a data storage device 220, a user retention platform 230 hosted within a cloud computing environment 240, and/or a network 250. Devices of environment 200 may interconnect via wired connections, wireless connections, or a combination of wired and wireless connections.

User device 210 includes one or more devices capable of receiving, generating, storing, processing, and/or providing data described herein. For example, user device 210 may include a device or machine, such as a mobile phone (e.g., a smart phone, a radiotelephone, and/or the like), a laptop computer, a tablet computer, a handheld computer, a server computer, a gaming device, a wearable communication device (e.g., a smart wristwatch, a pair of smart eyeglasses, and/or the like), or a similar type of device or machine.

In some implementations, a first user device 210 may provide a request to user retention platform 230. For example, the first user device 210 may be associated with an employee or agent of a service provider, and the employee or agent may use the first user device 210 to provide, to user retention platform 230, a request to provide one or more other user devices 210 associated with customers of the service provider with one or more services packages, as described elsewhere herein.

Data storage device 220 includes one or more devices capable of receiving, storing, generating, determining, and/or providing data associated with one or more data models. For example, data storage device 220 may include a server device or a group of server devices. In some implementations, a first data storage device 220 may store user data, network performance indicator (NPI) values, user statistics data, and/or any other data that may be used to train one or more data models. In some implementations, a set of data storage devices 220 may store different types of data that may be used to train one or more data models. For example, a first data storage device 220 may store user data, a second data storage device 220 may store NPI values, and a third data storage device 220 may store additional user data and/or network data (e.g., a third data storage device 220 may store online footprint data for a user, and/or the like).

User retention platform 230 includes one or more devices capable of receiving, storing, generating, determining, and/or providing data described herein. For example, user retention platform 230 may include a server device (e.g., a host server, a web server, an application server, and/or the like), a data center device, or a similar device. In some implementations, user retention platform 230 may support a user retention management application and/or a user retention management website that may provide a front-end user interface to allow employees or agents of a service provider to submit requests to user retention platform 230, as described elsewhere herein. In some implementations, user retention platform 230 may obtain user data and/or NPI values from data storage device 220. In some implementations, user retention platform 230 may train a first set of data models, a second set of data models, and/or a third set of data models. In some implementations, user retention platform 230 may receive the first set of data models, the second set of data models, and/or the third set of data models (which may have been trained by another device) from another source.

In some implementations, as shown, user retention platform 230 may be hosted in cloud computing environment 240. In some implementations, user retention platform 230 might not be cloud-based (i.e., may be implemented outside of a cloud computing environment) or may be partially cloud-based.

Cloud computing environment 240 includes an environment that hosts user retention platform 230. Cloud computing environment 240 may provide computation, software, data access, storage, and/or the like services that do not require end-user knowledge of a physical location and configuration of system(s) and/or device(s) that hosts user retention platform 230. As shown, cloud computing environment 240 may include a group of computing resources 235 (referred to collectively as “computing resources 235” and individually as “computing resource 235”).

Computing resource 235 includes one or more personal computers, workstation computers, server devices, and/or another type of computation and/or communication device. In some implementations, computing resource 235 may host user retention platform 230. The cloud resources may include compute instances executing in computing resource 235, storage devices provided in computing resource 235, data transfer devices provided by computing resource 235, and/or the like. In some implementations, computing resource 235 may communicate with other computing resources 235 via wired connections, wireless connections, or a combination of wired and wireless connections.

As further shown in FIG. 2, computing resource 235 may include a group of cloud resources, such as one or more applications (“APPs”) 235-1, one or more virtual machines (“VMs”) 235-2, virtualized storage (“VSs”) 235-3, one or more hypervisors (“HYPs”) 235-4, and/or the like.

Application 235-1 may include one or more software applications that may be provided to or accessed by user device 210 and/or data storage device 220. Application 235-1 may eliminate a need to install and execute the software applications on these devices. For example, application 235-1 may include software associated with user retention platform 230 and/or any other software capable of being provided via cloud computing environment 240. In some implementations, one application 235-1 may send/receive information to/from one or more other applications 235-1, via virtual machine 235-2.

Virtual machine 235-2 may include a software implementation of a machine (e.g., a computer) that executes programs like a physical machine. Virtual machine 235-2 may be either a system virtual machine or a process virtual machine, depending upon use and degree of correspondence to any real machine by virtual machine 235-2. A system virtual machine may provide a complete system platform that supports execution of a complete operating system (“OS”). A process virtual machine may execute a single program and may support a single process. In some implementations, virtual machine 235-2 may execute on behalf of another device (e.g., user device 210, data storage device 220, and/or the like), and may manage infrastructure of cloud computing environment 240, such as data management, synchronization, or long-duration data transfers.

Virtualized storage 235-3 may include one or more storage systems and/or one or more devices that use virtualization techniques within the storage systems or devices of computing resource 235. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 235-4 may provide hardware virtualization techniques that allow multiple operating systems (e.g., “guest operating systems”) to execute concurrently on a host computer, such as computing resource 235. Hypervisor 235-4 may present a virtual operating platform to the guest operating systems and may manage the execution of the guest operating systems. Multiple instances of a variety of operating systems may share virtualized hardware resources.

Network 250 includes one or more wired and/or wireless networks. For example, network 250 may include a cellular network (e.g., a fifth generation (5G) network, a fourth generation (4G) network, such as a long-term evolution (LTE) network, a third generation (3G) network, a code division multiple access (CDMA) network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as one or more examples. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

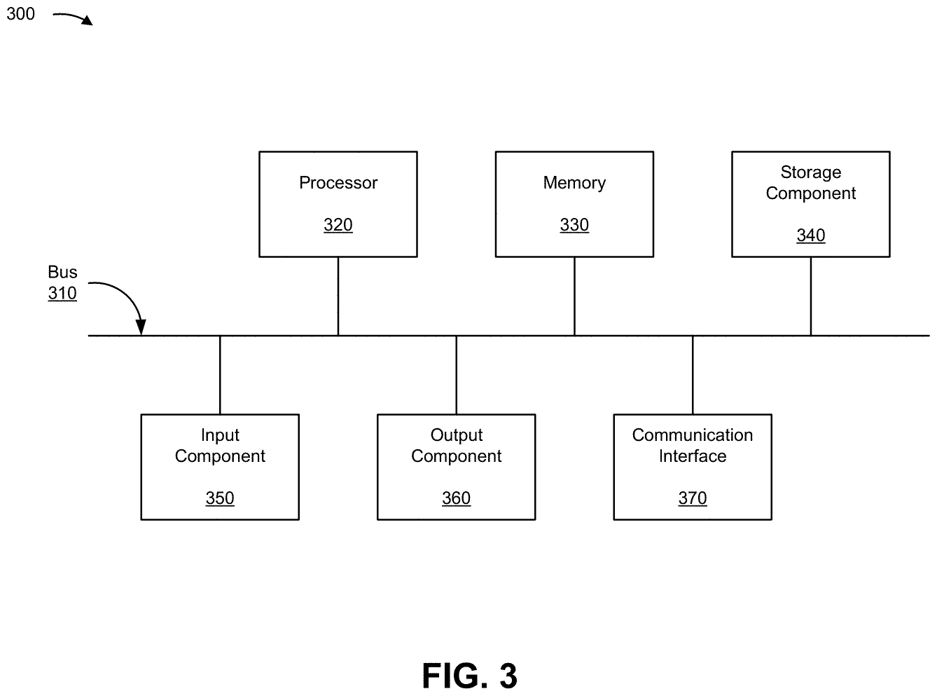

FIG. 3 is a diagram of example components of a device 300. Device 300 may correspond to user device 210, data storage device 220, and/or user retention platform 230. In some implementations, user device 210, data storage device 220, and/or user retention platform 230 may include one or more devices 300 and/or one or more components of device 300. As shown in FIG. 3, device 300 may include a bus 310, a processor 320, a memory 330, a storage component 340, an input component 350, an output component 360, and/or a communication interface 370.

Bus 310 includes a component that permits communication among multiple components of device 300. Processor 320 is implemented in hardware, firmware, and/or a combination of hardware and software. Processor 320 includes a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a component for determining location (e.g., a global positioning system (GPS) component) and/or a sensor (e.g., an accelerometer, a gyroscope, an actuator, another type of positional or environmental sensor, and/or the like). Output component 360 includes a component that provides output information from device 300 (via, e.g., a display, a speaker, a haptic feedback component, an audio or visual indicator, and/or the like).

Communication interface 370 includes a transceiver-like component (e.g., a transceiver, a separate receiver, a separate transmitter, and/or the like) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. As used herein, the term “computer-readable medium” refers to a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

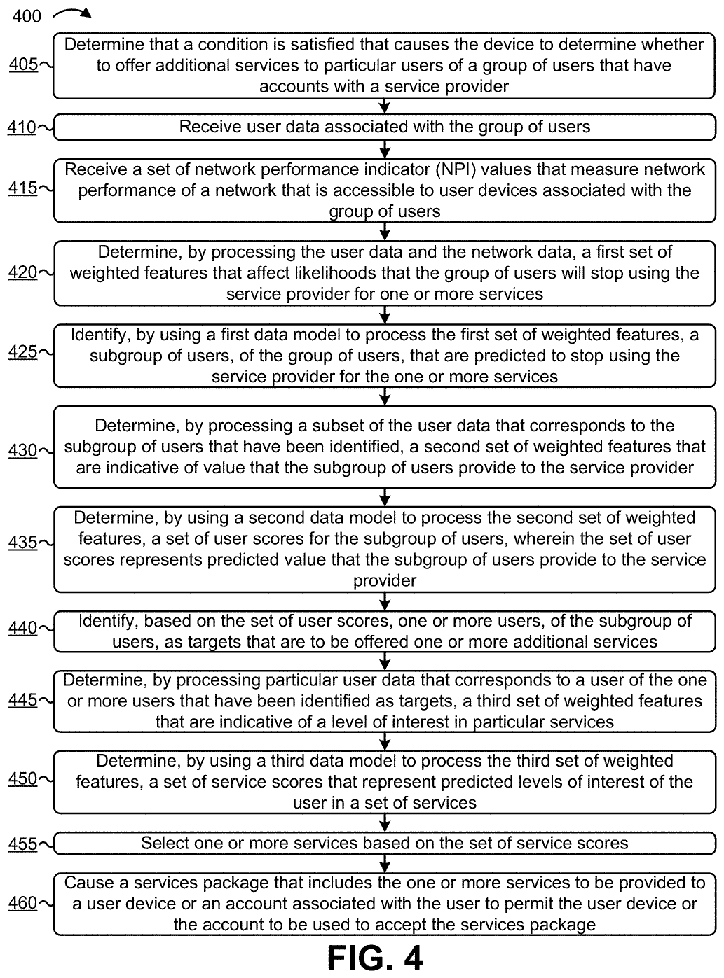

FIG. 4 is a flow chart of an example process 400 for identifying users who are predicted to stop using services of a service provider, for identifying that one or more of the users are high-value customers to the service provider, for identifying one or more additional services that are predicted to be of interest to a user, of the one or more users, and for causing a services package with the one or more additional services to be provided to a user device or user account associated with the user. In some implementations, one or more process blocks of FIG. 4 may be performed by a user retention platform (e.g., user retention platform 230). In some implementations, one or more process blocks of FIG. 4 may be performed by another device or a group of devices separate from or including the user retention platform, such as a user device (e.g., user device 210), a data storage device (e.g., data storage device 220), and/or the like.

As shown in FIG. 4, process 400 may include determining that a condition is satisfied that causes the device to determine whether to offer additional services to particular users of a group of users who have accounts with a service provider (block 405). For example, the user retention platform (e.g., using computing resource 235, processor 320, memory 330, storage component 340, input component 350, communication interface 370, and/or the like) may determine that a condition is satisfied that causes the device to determine whether to offer additional services to particular users of a group of users who have accounts with a service provider, as described above.

As further shown in FIG. 4, process 400 may include receiving user data associated with the group of users (block 410). For example, the user retention platform (e.g., using computing resource 235, processor 320, memory 330, storage component 340, input component 350, communication interface 370, and/or the like) may receive user data associated with the group of users, as described above. In some implementations, the user data includes at least one of: user account data, user behavioral data, or technical support data.

As further shown in FIG. 4, process 400 may include receiving a set of network performance indicator (NPI) values that measure network performance of a network that is accessible to user devices associated with the group of users (block 415). For example, the user retention platform (e.g., using computing resource 235, processor 320, memory 330, storage component 340, input component 350, communication interface 370, and/or the like) may receive a set of NPI values that measure network performance of a network that is accessible to user devices associated with the group of users, as described above.

As further shown in FIG. 4, process 400 may include determining, by processing the user data and the set of NPI values, a first set of weighted features that affect likelihoods that the group of users will stop using the service provider for one or more services (block 420). For example, the user retention platform (e.g., using computing resource 235, processor 320, memory 330, storage component 340, and/or the like) may determine, by processing the user data and the set of NPI values, a first set of weighted features that affect likelihoods that the group of users will stop using the service provider for one or more services, as described above.

As further shown in FIG. 4, process 400 may include identifying, by using a first data model to process the first set of weighted features, a subgroup of users, of the group of users, that are predicted to stop using the service provider for one or more services (block 425). For example, the user retention platform (e.g., using computing resource 235, processor 320, memory 330, storage component 340, and/or the like) may identify, by using a first data model to process the first set of weighted features, a subgroup of users, of the group of users, that are predicted to stop using the service provider for one or more services, as described above.

As further shown in FIG. 4, process 400 may include determining, by processing a subset of the user data that corresponds to the subgroup of users who have been identified, a second set of weighted features that are indicative of value that the subgroup of users provide to the service provider (block 430). For example, the user retention platform (e.g., using computing resource 235, processor 320, memory 330, storage component 340, and/or the like) may determine, by processing a subset of the user data that corresponds to the subgroup of users who have been identified, a second set of weighted features that are indicative of value that the subgroup of users provide to the service provider, as described above.

As further shown in FIG. 4, process 400 may include determining, by using a second data model to process the second set of weighted features, a set of user scores for the subgroup of users, wherein the set of user scores represents predicted value that the subgroup of users provide to the service provider (block 435). For example, the user retention platform (e.g., using computing resource 235, processor 320, memory 330, storage component 340, and/or the like) may determine, by using a second data model to process the second set of weighted features, a set of user scores for the subgroup of users, as described above. In some implementations, the set of user scores represents predicted value that the subgroup of users may provide to the service provider.

As further shown in FIG. 4, process 400 may include identifying, based on the set of user scores, one or more users, of the subgroup of users, as targets that are to be offered one or more additional services (block 440). For example, the user retention platform (e.g., using computing resource 235, processor 320, memory 330, storage component 340, and/or the like) may identify, based on the set of user scores, one or more users, of the subgroup of users, as targets that are to be offered one or more additional services, as described above.

As further shown in FIG. 4, process 400 may include determining, by processing particular user data that corresponds to a user of the one or more users who have been identified as targets, a third set of weighted features that are indicative of a level of interest in particular services (block 445). For example, the user retention platform (e.g., using computing resource 235, processor 320, memory 330, storage component 340, and/or the like) may determine, by processing particular user data that corresponds to a user of the one or more users who have been identified as targets, a third set of weighted features that are indicative of a level of interest in particular services, as described above.

As further shown in FIG. 4, process 400 may include determining, by using a third data model to process the third set of weighted features, a set of service scores that represent predicted levels of interest of the user in a set of services (block 450). For example, the user retention platform (e.g., using computing resource 235, processor 320, memory 330, storage component 340, and/or the like) may determine, by using a third data model to process the third set of weighted features, a set of service scores that represent predicted levels of interest of the user in a set of services, as described above.

As further shown in FIG. 4, process 400 may include selecting one or more services based on the set of service scores (block 455). For example, the user retention platform (e.g., using computing resource 235, processor 320, memory 330, storage component 340, and/or the like) may select one or more services of the set of services based on the set of service scores, as described above.

As further shown in FIG. 4, process 400 may include causing a services package that includes the one or more services to be provided to a user device or an account associated with the user to permit the user device or the account to be used to accept the services package (block 460). For example, the user retention platform (e.g., using computing resource 235, processor 320, memory 330, storage component 340, input component 350, output component 360, communication interface 370, and/or the like) may cause a services package that includes the one or more services to be provided to a user device or an account associated with the user to permit the user device or the account to be used to accept the services package, as described above.

Process 400 may include additional implementations, such as any single implementation or any combination of implementations described below and/or in connection with one or more other processes described elsewhere herein.

In some implementations, when determining the first set of weighted features, the user retention platform may determine a first set of features by processing the user data and the set of NPI values. Additionally, the user retention platform may determine a first set of weights by processing the first set of features using one or more feature weighting techniques that are driven by machine learning. Additionally, the user retention platform may determine the first set of weighted features by assigning the first set of weights to the first set of features.

In some implementations, before identifying the subgroup of users, the user retention platform may perform an evaluation on a set of data models that are capable of predicting when users will stop using the service provider. In some implementations, the user retention platform may select the first data model, of the set of data models, based on a result of the evaluation.

In some implementations, before determining the set of user scores, the user retention platform may perform an evaluation on a set of data models that are capable of predicting value that the subgroup of users provide to the service provider. In some implementations, the user retention platform may select the second data model, of the set of data models, based on a result of the evaluation.

In some implementations, before determining the set of service scores, the user retention platform may perform an evaluation on a set of data models that are capable of predicting levels of interest of the user in a set of services. In some implementations, the user retention platform may select the third data model, of the set of data models, based on a result of the evaluation.

In some implementations, the first data model may include a classification artificial intelligence (AI) model. In some implementations, the second data model may include a regression AI model. In some implementations, the third data model may include a particular classification AI model or a particular regression AI model.

In some implementations, the user data may include technical support data. In some implementations, the technical support data may include call center data that describes one or more conversations between the user and one or more customer service representatives. In some implementations, when identifying the subgroup of users, the user retention platform may provide the first set of weighted features as input to the first data model to cause the first data model to output a churn score that represents a predicted likelihood that the user stops using the service provider. In some implementations, the churn score may be based on a sentiment analysis of the one or more conversations between the user and the one or more customer service representatives.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

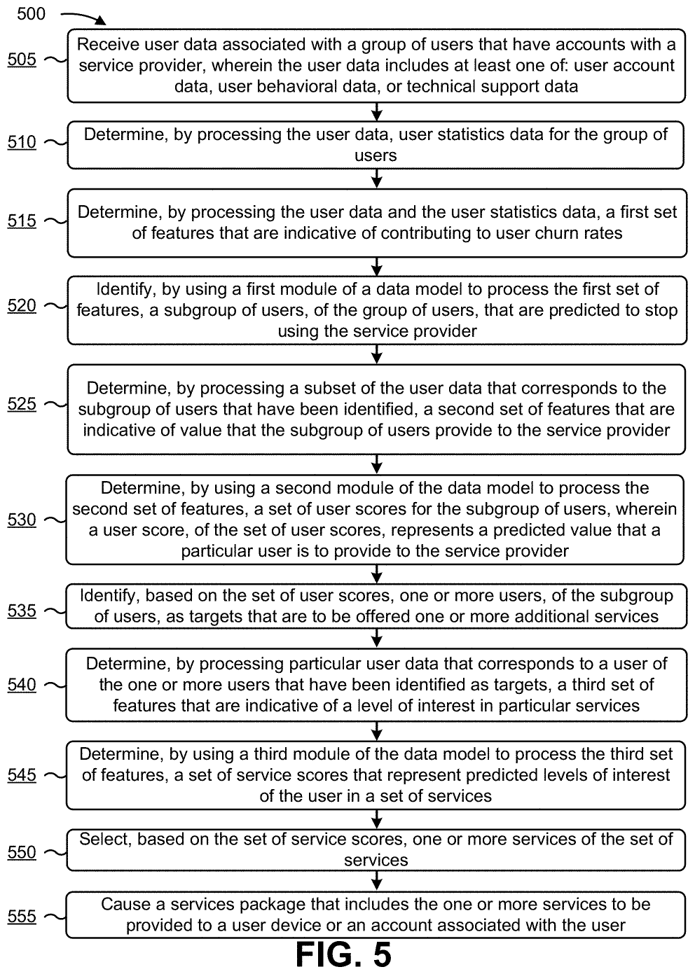

FIG. 5 is a flow chart of an example process 500 for identifying users who are predicted to stop using services of a service provider, for identifying that one or more of the users are high-value customers to the service provider, for identifying one or more additional services that are predicted to be of interest to a user, of the one or more users, and for causing a services package with the one or more additional services to be provided to a user device or user account associated with the user. In some implementations, one or more process blocks of FIG. 5 may be performed by a user retention platform (e.g., user retention platform 230). In some implementations, one or more process blocks of FIG. 5 may be performed by another device or a group of devices separate from or including the user retention platform, such as a user device (e.g., user device 210), a data storage device (e.g., data storage device 220), and/or the like.

As shown in FIG. 5, process 500 may include receiving user data associated with a group of users who have accounts with a service provider, wherein the user data includes at least one of: user account data, user behavioral data, or technical support data (block 505). For example, the user retention platform (e.g., using computing resource 235, processor 320, memory 330, storage component 340, input component 350, communication interface 370, and/or the like) may receive user data associated with a group of users who have accounts with a service provider, as described above. In some implementations, the user data includes at least one of: user account data, user behavioral data, or technical support data.

As further shown in FIG. 5, process 500 may include determining, by processing the user data, user statistics data for the group of users (block 510). For example, the user retention platform (e.g., using computing resource 235, processor 320, memory 330, storage component 340, and/or the like) may determine, by processing the user data, user statistics data for the group of users, as described above.

As further shown in FIG. 5, process 500 may include determining, by processing the user data and the user statistics data, a first set of features that are indicative of contributing to user churn rates (block 515). For example, the user retention platform (e.g., using computing resource 235, processor 320, memory 330, storage component 340, and/or the like) may determine, by processing the user data and the user statistics data, a first set of features that are indicative of contributing to user churn rates, as described above.

As further shown in FIG. 5, process 500 may include identifying, by using a first module of a data model to process the first set of features, a subgroup of users, of the group of users, who are predicted to stop using the service provider (block 520). For example, the user retention platform (e.g., using computing resource 235, processor 320, memory 330, storage component 340, and/or the like) may identify, by using a first module of a data model to process the first set of features, a subgroup of users, of the group of users, who are predicted to stop using the service provider, as described above.

As further shown in FIG. 5, process 500 may include determining, by processing a subset of the user data that corresponds to the subgroup of users who have been identified, a second set of features that are indicative of value that the subgroup of users provide to the service provider (block 525). For example, the user retention platform (e.g., using computing resource 235, processor 320, memory 330, storage component 340, and/or the like) may determine, by processing a subset of the user data that corresponds to the subgroup of users who have been identified, a second set of features that are indicative of value that the subgroup of users provide to the service provider, as described above.

As further shown in FIG. 5, process 500 may include determining, by using a second module of the data model to process the second set of features, a set of user scores for the subgroup of users, wherein a user score, of the set of user scores, represents a predicted value that a particular user is to provide to the service provider (block 530). For example, the user retention platform (e.g., using computing resource 235, processor 320, memory 330, storage component 340, and/or the like) may determine, by using a second module of the data model to process the second set of features, a set of user scores for the subgroup of users, as described above. In some implementations, a user score, of the set of user scores, may represent a predicted value that a particular user is to provide to the service provider.

As further shown in FIG. 5, process 500 may include identifying, based on the set of user scores, one or more users, of the subgroup of users, as targets that are to be offered one or more additional services (block 535). For example, the user retention platform (e.g., using computing resource 235, processor 320, memory 330, storage component 340, and/or the like) may identify, based on the set of user scores, one or more users, of the subgroup of users, as targets that are to be offered one or more additional services, as described above.

As further shown in FIG. 5, process 500 may include determining, by processing particular user data that corresponds to a user of the one or more users who have been identified as targets, a third set of features that are indicative of a level of interest in particular services (block 540). For example, the user retention platform (e.g., using computing resource 235, processor 320, memory 330, storage component 340, and/or the like) may determine, by processing particular user data that corresponds to a user of the one or more users who have been identified as targets, a third set of features that are indicative of a level of interest in particular services, as described above.

As further shown in FIG. 5, process 500 may include determining, by using a third module of the data model to process the third set of features, a set of service scores that represent predicted levels of interest of the user in a set of services (block 545). For example, the user retention platform (e.g., using computing resource 235, processor 320, memory 330, storage component 340, and/or the like) may determine, by using a third module of the data model to process the third set of features, a set of service scores that represent predicted levels of interest of the user in a set of services, as described above.

As further shown in FIG. 5, process 500 may include selecting, based on the set of service scores, one or more services of the set of services (block 550). For example, the user retention platform (e.g., using computing resource 235, processor 320, memory 330, storage component 340, and/or the like) may select, based on the set of service scores, one or more services of the set of services, as described above.

As further shown in FIG. 5, process 500 may include causing a services package that includes the one or more services to be provided to a user device or an account associated with the user (block 555). For example, the user retention platform (e.g., using computing resource 235, processor 320, memory 330, storage component 340, input component 350, output component 360, communication interface 370, and/or the like) may cause a services package that includes the one or more services to be provided to a user device or an account associated with the user, as described above.

Process 500 may include additional implementations, such as any single implementation or any combination of implementations described below and/or in connection with one or more other processes described elsewhere herein.

In some implementations, the user retention platform may train the second module of the data model by using one or more machine learning techniques to process historical user data. In some implementations, the one or more machine learning techniques may be used to identify a set of correlations between user behavior of users and value that the users add to the service provider.

In some implementations, before identifying the subgroup of users, the user retention platform may select the first module of the data model, of a first set of available modules, based on a first evaluation of the first set of available modules. In some implementations, before determining the set of user scores, the user retention platform may select a second module of the data model, of a second set of available modules, based on a second evaluation of the second set of available modules. In some implementations, before determining the set of service scores, the user retention platform may select a third module of the data model, of a third set of available modules, based on a third evaluation of the third set of available modules.

In some implementations, the first set of features may be a first set of weighted features. In some implementations, the second set of features may be a second set of weighted features. In some implementations, the third set of features may be a third set of weighted features. In some implementations, each user, of the subgroup of users, may be predicted to stop using the service provider within a particular time period.

In some implementations, the user retention platform may receive a set of network performance indicator (NPI) values that measure network performance of a network that is accessible to user devices associated with the group of users over a given time period. In some implementations, when determining the first set of features, the user retention platform may determine one or more additional features, as part of the first set of features, by using one or more feature determination techniques to process the set of NPI values.

In some implementations, the user data may include online footprint data. In some implementations, the online footprint data may include data that describes a set of reviews that the user has made relating to the service provider. In some implementations, when identifying the subgroup of users, the user retention platform may provide the second set of features as input to the second module of the data model to cause the second module to output a particular user score that corresponds to the user. In some implementations, the particular user score may be based on a sentiment analysis of the set of reviews that the user has made.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

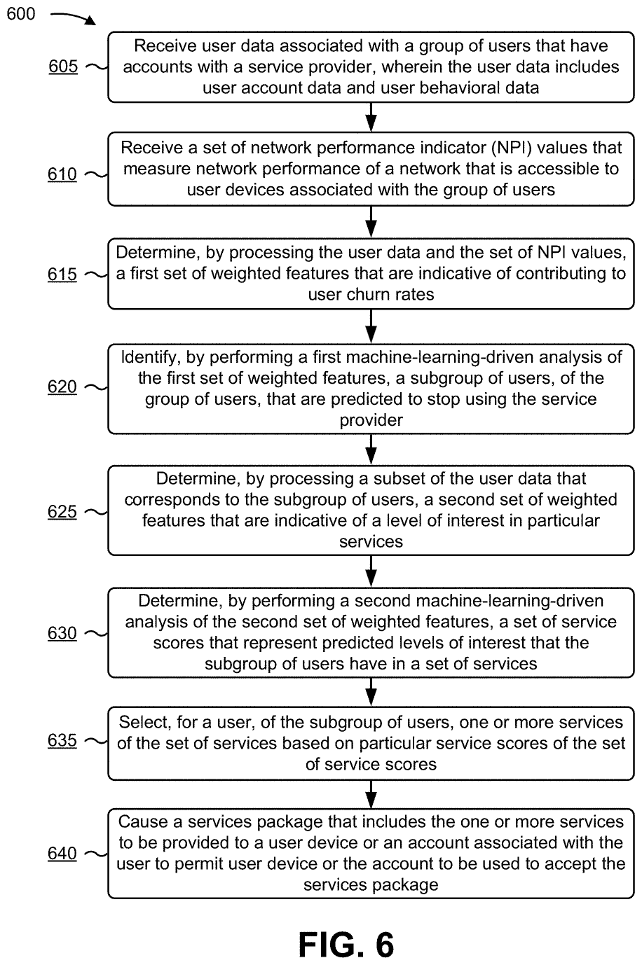

FIG. 6 is a flow chart of an example process 600 for identifying users who are predicted to stop using services of a service provider, for identifying that one or more of the users are high-value customers to the service provider, for identifying one or more additional services that are predicted to be of interest to a user, of the one or more users, and for causing a services package with the one or more additional services to be provided to a user device or user account associated with the user. In some implementations, one or more process blocks of FIG. 6 may be performed by a user retention platform (e.g., user retention platform 230). In some implementations, one or more process blocks of FIG. 6 may be performed by another device or a group of devices separate from or including the user retention platform, such as a user device (e.g., user device 210), a data storage device (e.g., data storage device 220), and/or the like.

As shown in FIG. 6, process 600 may include receiving user data associated with a group of users who have accounts with a service provider, wherein the user data includes user account data and user behavioral data (block 605). For example, the user retention platform (e.g., using computing resource 235, processor 320, memory 330, storage component 340, input component 350, communication interface 370, and/or the like) may receive user data associated with a group of users who have accounts with a service provider, as described above. In some implementations, the user data may include user account data and user behavioral data.

As further shown in FIG. 6, process 600 may include receiving a set of network performance indicator (NPI) values that measure network performance of a network that is accessible to user devices associated with the group of users (block 610). For example, the user retention platform (e.g., using computing resource 235, processor 320, memory 330, storage component 340, input component 350, communication interface 370, and/or the like) may receive a set of NPI values that measure network performance of a network that is accessible to user devices (e.g., user devices 210) associated with the group of users, as described above.

As further shown in FIG. 6, process 600 may include determining, by processing the user data and the set of NPI values, a first set of weighted features that are indicative of contributing to user churn rates (block 615). For example, the user retention platform (e.g., using computing resource 235, processor 320, memory 330, storage component 340, and/or the like) may determine, by processing the user data and the set of NPI values, a first set of weighted features that are indicative of contributing to user churn rates, as described above.

As further shown in FIG. 6, process 600 may include identifying, by performing a first machine-learning-driven analysis of the first set of weighted features, a subgroup of users, of the group of users, that are predicted to stop using the service provider (block 620). For example, the user retention platform (e.g., using computing resource 235, processor 320, memory 330, storage component 340, and/or the like) may identify, by performing a first machine-learning-driven analysis of the first set of weighted features, a subgroup of users, of the group of users, that are predicted to stop using the service provider, as described above.

As further shown in FIG. 6, process 600 may include determining, by processing a subset of the user data that corresponds to the subgroup of users, a second set of weighted features that are indicative of a level of interest in particular services (block 625). For example, the user retention platform (e.g., using computing resource 235, processor 320, memory 330, storage component 340, and/or the like) may determine, by processing a subset of the user data that corresponds to the subgroup of users, a second set of weighted features that are indicative of a level of interest in particular services, as described above.

As further shown in FIG. 6, process 600 may include determining, by performing a second machine-learning-driven analysis of the second set of weighted features, a set of service scores that represent predicted levels of interest that the subgroup of users have in a set of services (block 630). For example, the user retention platform (e.g., using computing resource 235, processor 320, memory 330, storage component 340, and/or the like) may determine, by performing a second machine-learning-driven analysis of the second set of weighted features, a set of service scores that represent predicted levels of interest that the subgroup of users have in a set of services, as described above.

As further shown in FIG. 6, process 600 may include selecting, for a user, of the subgroup of users, one or more services of the set of services based on particular service scores of the set of service scores (block 635). For example, the user retention platform (e.g., using computing resource 235, processor 320, memory 330, storage component 340, and/or the like) may select, for a user, of the subgroup of users, one or more services of the set of services based on particular service scores of the set of service scores, as described above.

As further shown in FIG. 6, process 600 may include causing a services package that includes the one or more services to be provided to a user device or an account associated with the user to permit user device or the account to be used to accept the services package (block 640). For example, the user retention platform (e.g., using computing resource 235, processor 320, memory 330, storage component 340, input component 350, output component 360, communication interface 370, and/or the like) may cause a services package that includes the one or more services to be provided to a user device or an account associated with the user to permit user device or the account to be used to accept the services package, as described above.

Process 600 may include additional implementations, such as any single implementation or any combination of implementations described below and/or in connection with one or more other processes described elsewhere herein.

In some implementations, the user retention platform may determine, by processing the subset of the user data that corresponds to the subgroup of users who have been identified, a third set of weighted features that are indicative of contributing to value that the subgroup of users provide to the service provider. In some implementations, the user retention platform may determine, by performing a third machine-learning-driven analysis of the third set of weighted features, a set of user scores for the subgroup of users. In some implementations, the set of user scores may represent predicted value that the subgroup of users provide to the service provider. In some implementations, the user retention platform may identify, based on the set of user scores, one or more users, of the subgroup of users, as targets that are to be offered one or more additional services. In some implementations, the set of service scores determined by performing the second machine-learning-driven analysis may represent predicted levels of interest that the one or more users have in the set of services.

In some implementations, the user retention platform may train a data model, which is to be used as part of the second machine-learning-driven analysis, by using one or more machine learning techniques to process historical user data and historical NPI values. In some implementations, the one or more machine learning techniques may be used to create groups of personality profiles of users who share particular features.

In some implementations, the user retention platform may perform a first evaluation on a first set of data models that are capable of being used as part of the first machine-learning-driven analysis. In some implementations, the user retention platform may select a first data model, of the first set of data models, based on a result of the first evaluation. In some implementations, the user retention platform may perform a second evaluation on a second set of data models that are capable of being used as part of the second machine-learning-driven analysis. In some implementations, the user retention platform may select a second data model, of the second set of data models, based on a result of the second evaluation.

In some implementations, the user retention platform may determine the second set of weighted features by processing the subset of the user data that corresponds to the subgroup of users. In some implementations, the user retention platform may determine a set of weights by processing the set of features using one or more feature weighting techniques. In some implementations, the user retention platform may determine the second set of weighted features by assigning the set of weights to the set of features.

In some implementations, the user data includes technical support data and online footprint data. In some implementations, when determining the set of service scores, the user retention platform may perform the second machine-learning-driven analysis of the second set of weighted features to generate the set of service scores. In some implementations, the set of service scores may be based on a sentiment analysis of statements made by the user as found in the technical support data or the online footprint data.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, and/or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, and/or the like). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
determining, by a device, that a condition is satisfied that causes the device to determine whether to offer additional services to particular users of a group of users who have accounts with a service provider;
receiving, by the device, user data associated with the group of users, wherein the user data includes at least one of user account data, user behavioral data, or technical support data;
receiving, by the device, a set of network performance indicator (NPI) values that measure network performance of a network that is accessible to user devices associated with the group of users;
determining, by the device and by processing the user data and the set of NPI values, a first set of weighted features that affect likelihoods that the group of users will stop using the service provider for one or more services;
identifying, by the device and by using a first data model to process the first set of weighted features, a subgroup of users, of the group of users, that are predicted to stop using the service provider for the one or more services;
determining, by the device and by processing a subset of the user data that corresponds to the subgroup of users who have been identified, a second set of weighted features that are indicative of value that the subgroup of users provide to the service provider;
determining, by the device and by using a second data model to process the second set of weighted features, a set of user scores for the subgroup of users, wherein the set of user scores represents predicted value that the subgroup of users provide to the service provider;
identifying, by the device and based on the set of user scores, one or more users, of the subgroup of users, as targets that are to be offered one or more additional services;
determining, by the device and by processing particular user data that corresponds to a user of the one or more users who have been identified as targets, a third set of weighted features that are indicative of a level of interest in particular services;
determining, by the device and by using a third data model to process the third set of weighted features, a set of service scores that represent predicted levels of interest of the user in a set of services;
selecting, by the device and based on the set of service scores, one or more services of the set of services; and
causing, by the device, a services package that includes the one or more services to be provided to a user device or an account associated with the user to permit the user device or the account to be used to accept the services package.

2. The method of claim 1, wherein determining the first set of weighted features comprises:
determining a first set of features by processing the user data and the set of NPI values,
determining a first set of weights by processing the first set of features using one or more feature weighting techniques that are driven by machine learning, and
determining the first set of weighted features by assigning the first set of weights to the first set of features.

3. The method of claim 1, further comprising:
performing, before identifying the subgroup of users, an evaluation on a set of data models that are capable of predicting when users will stop using the service provider; and
selecting the first data model, of the set of data models, based on a result of the evaluation.

4. The method of claim 1, further comprising:
performing, before determining the set of user scores, an evaluation on a set of data models that are capable of predicting value that the subgroup of users provide to the service provider; and
selecting the second data model, of the set of data models, based on a result of the evaluation.

5. The method of claim 1, further comprising:
performing, before determining the set of service scores, an evaluation on a set of data models that are capable of predicting levels of interest of the user in a set of services; and
selecting the third data model, of the set of data models, based on a result of the evaluation.

6. The method of claim 1, wherein the first data model comprises a classification artificial intelligence (AI) model;
wherein the second data model comprises a regression AI model; and
wherein the third data model comprises a particular classification AI model or a particular regression AI model.

7. The method of claim 1, wherein the user data includes the technical support data;
wherein the technical support data includes call center data that describes one or more conversations between the user and one or more customer service representatives; and
wherein identifying the subgroup of users comprises:
providing the first set of weighted features as input to the first data model to cause the first data model to output a churn score that represents a predicted likelihood that the user stops using the service provider,
wherein the churn score is based on a sentiment analysis of the one or more conversations between the user and the one or more customer service representatives.

8. A device, comprising:
one or more memories; and
one or more processors, operatively coupled to the one or more memories, to:
receive user data associated with a group of users who have accounts with a service provider, wherein the user data includes at least one of user account data, user behavioral data, or technical support data;
determine, by processing the user data, user statistics data for the group of users;
determine, by processing the user data and the user statistics data, a first set of features that are indicative of contributing to user churn rates;
identify, by using a first module of a data model to process the first set of features, a subgroup of users, of the group of users, that are predicted to stop using the service provider;
determine, by processing a subset of the user data that corresponds to the subgroup of users who have been identified, a second set of features that are indicative of value that the subgroup of users provide to the service provider;
determine, by using a second module of the data model to process the second set of features, a set of user scores for the subgroup of users, wherein a user score, of the set of user scores, represents a predicted value that a particular user is to provide to the service provider;
identify, based on the set of user scores, one or more users, of the subgroup of users, as targets that are to be offered one or more additional services;
determine, by processing particular user data that corresponds to a user of the one or more users who have been identified as targets, a third set of features that are indicative of a level of interest in particular services;
determine, by using a third module of the data model to process the third set of features, a set of service scores that represent predicted levels of interest of the user in a set of services;
select, based on the set of service scores, one or more services of the set of services; and
cause a services package that includes the one or more services to be provided to a user device or an account associated with the user.

9. The device of claim 8, wherein the one or more processors are further to:
train the second module of the data model by using one or more machine learning techniques to process historical user data,
wherein the one or more machine learning techniques are used to identify a set of correlations between user behavior of users and particular value that the users add to the service provider.

10. The device of claim 8, wherein the one or more processors are further to:
select, before identifying the subgroup of users, the first module of the data model, of a first set of available modules, based on a first evaluation of the first set of available modules;
select, before determining the set of user scores, the second module of the data model, of a second set of available modules, based on a second evaluation of the second set of available modules; and
select, before determining the set of service scores, the third module of the data model, of a third set of available modules, based on a third evaluation of the third set of available modules.

11. The device of claim 8, wherein the first set of features are a first set of weighted features;
wherein the second set of features are a second set of weighted features; and
wherein the third set of features are a third set of weighted features.

12. The device of claim 8, wherein each user, of the subgroup of users, is predicted to stop using the service provider within a particular time period.

13. The device of claim 8, wherein the one or more processors are further to:
receive a set of network performance indicator (NPI) values that measure network performance of a network that is accessible to user devices associated with the group of users over a given time period; and
wherein the one or more processors, when determining the first set of features, are to:
determine, as part of the first set of features, one or more additional features by using one or more feature determination techniques to process the set of NPI values.

14. The device of claim 8, wherein the user data further includes online footprint data;
wherein the online footprint data includes data that describes a set of reviews that the user has made relating to the service provider; and
wherein the one or more processors, when identifying the subgroup of users, are to:
provide the second set of features as input to the second module of the data model to cause the second module to output a particular user score that corresponds to the user,
wherein the particular user score is based on a sentiment analysis of the set of reviews that the user has made.

15. A non-transitory computer-readable medium storing instructions, the instructions comprising:
one or more instructions that, when executed by one or more processors, cause the one or more processors to:
receive user data associated with a group of users who have accounts with a service provider, wherein the user data includes user account data and user behavioral data;
receive a set of network performance indicator (NPI) values that measure network performance of a network that is accessible to user devices associated with the group of users;
determine, by processing the user data and the set of NPI values, a first set of weighted features that are indicative of contributing to user churn rates;
identify, by performing a first machine-learning-driven analysis of the first set of weighted features, a subgroup of users, of the group of users, that are predicted to stop using the service provider;
determine, by processing a subset of the user data that corresponds to the subgroup of users, a second set of weighted features that are indicative of a level of interest in particular services;
determine, by performing a second machine-learning-driven analysis of the second set of weighted features, a set of service scores that represent predicted levels of interest that the subgroup of users have in a set of services;
select, for a user, of the subgroup of users, one or more services of the set of services based on particular service scores of the set of service scores; and
cause a services package that includes the one or more services to be provided to a user device or an account associated with the user to permit user device or the account to be used to accept the services package.

16. The non-transitory computer-readable medium of claim 15, wherein the one or more instructions, when executed by the one or more processors, further cause the one or more processors to:
determine, by processing the subset of the user data that corresponds to the subgroup of users who have been identified, a third set of weighted features that are indicative value that the subgroup of users provide to the service provider;
determine, by performing a third machine-learning-driven analysis of the third set of weighted features, a set of user scores for the subgroup of users,
wherein the set of user scores represents predicted value that the subgroup of users provide to the service provider; and
identify, based on the set of user scores, one or more users, of the subgroup of users, as targets that are to be offered one or more additional services,
wherein the set of service scores determined by performing the second machine-learning-driven analysis represent predicted levels of interest that the one or more users have in the set of services.

17. The non-transitory computer-readable medium of claim 15, wherein the one or more instructions, when executed by the one or more processors, further cause the one or more processors to:
train a data model, which is to be used as part of the second machine-learning-driven analysis, by using one or more machine learning techniques to process historical user data and historical NPI values,
wherein the one or more machine learning techniques are used to create groups of personality profiles of users who share particular features.

18. The non-transitory computer-readable medium of claim 15, wherein the one or more instructions, when executed by the one or more processors, further cause the one or more processors to:
perform a first evaluation on a first set of data models that are capable of being used as part of the first machine-learning-driven analysis;
select a first data model, of the first set of data models, based on a result of the first evaluation;
perform a second evaluation on a second set of data models that are capable of being used as part of the second machine-learning-driven analysis; and
select a second data model, of the second set of data models, based on a result of the second evaluation.

19. The non-transitory computer-readable medium of claim 15, wherein the one or more instructions, that cause the one or more processors to determine the second set of weighted features, cause the one or more processors to:
determine a set of features by processing the subset of the user data that corresponds to the subgroup of users,
determine a set of weights by processing the set of features using one or more feature weighting techniques, and
determine the second set of weighted features by assigning the set of weights to the set of features.

20. The non-transitory computer-readable medium of claim 15, wherein the user data further includes technical support data and online footprint data; and
wherein the one or more instructions, that cause the one or more processors to determine the set of service scores, cause the one or more processors to:
perform the second machine-learning-driven analysis of the second set of weighted features to generate the set of service scores,
wherein the set of service scores are based on a sentiment analysis of statements made by the user as found in the technical support data or the online footprint data.
